(19) United States
(12) Patent Application Publication
(10) Pub. No.: US 2015/0172396 A1
(43) Pub. Date: Jun. 18, 2015

(54) SYSTEMS AND METHODS FOR ENRICHING GEOGRAPHICALLY DELINEATED CONTENT

(71) Applicant: CO EVERYWHERE, INC., Boston, MA (US)

(72) Inventors: Anthony Longo, Boston, MA (US); Daniel Alan Adams, Melrose, MA (US)

(21) Appl. No.: 14/610,071

(22) Filed: Jan. 30, 2015

Related U.S. Application Data
(63) Continuation-in-part of application No. 14/572,270, filed on Dec. 16, 2014.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.

(51) Int. Cl. H04L 29/08; G06F 17/30; H04L 12/58

(52) U.S. Cl. CPC H04L 67/18; H04L 51/32; G06F 17/30864

(57) ABSTRACT

Systems and methods are provided that enhance and provide geographically delineated content. In one implementation, a system comprises a location-based service including a distributed computer system having at least one processor, a delineation component configured to query at least one social media content provider and aggregate geographically delineated content including a plurality of media posts each generated by an author, a deconstruction component configured to automatically deconstruct individual media posts of the plurality of media posts into a plurality of dimensions, an enrichment component configured to: automatically aggregate enrichment data related to one of the dimensions of each of the individual media posts, enrichment data including at least author profile information associated with an author profile of the author that generated the respective media post, and responsive to aggregating the enrichment data, enhancing the plurality of media posts with the enrichment data to generate enriched aggregated geographically delineated content.

### RELATED APPLICATIONS

This application is a Continuation in Part of U.S. patent application Ser. No. 14/572,270, titled “Systems and Methods for Providing Geographically Delineated Content,” filed Dec. 16, 2014, which is incorporated herein by reference in its entirety. U.S. patent application Ser. No. 14/572,270 claims priority under 35 U.S.C. §119(e) to U.S. Provisional Patent Application Ser. No. 61/963,849 entitled “Methods of Geographic Delineation,” filed on Dec. 16, 2013, which application is herein incorporated by reference in its entirety. U.S. patent application Ser. No. 14/572,270 also claims priority under 35 U.S.C. §119(e) to U.S. Provisional Patent Application Ser. No. 61/963,850 entitled “Content Provision by Geographic Delineation,” filed on Dec. 16, 2013, which application is herein incorporated by reference in its entirety. U.S. patent application Ser. No. 14/572,270 further claims priority under 35 U.S.C. §119(e) to U.S. Provisional Patent Application Ser. No. 61/995,015 entitled “Methods for Geographic Delineation,” filed on Apr. 1, 2014, which application is herein incorporated by reference in its entirety.

### BACKGROUND

There are many companies that provide, consume, and transfer social networking information via the Internet, such as Twitter, Facebook, MySpace, LinkedIn, Pinterest, Foursquare, Yelp, Tripadvisor and Tumblr, among others. Social networking sites allow individuals to access social media content related to business and commerce, as well as personal needs and desires. Content often includes text, photographs, videos, and audio files. Also, some social media content providers provide location-based capabilities such as, for example, permitting a user to perform actions based on location. For example, within one type of location-based social network, users are permitted to perform a “check-in” to particular locations, including venues such as businesses, retail locations, events, points of interest, or other locations. A check-in generally includes a process that identifies the user with a particular location at a given time, and may be recorded over time. Accordingly, location-based social networks permit users to find venues of interest, find content of interest, interact with friends, and leave comments regarding particular locations, among other functions.

### SUMMARY

Conventional location-based social media content providers connect users with a variety of artificial criteria that do not permit the exchange of relevant information in real-time communication. Furthermore, conventional services for providing content are limited in the content that can be distributed or associated with additional information. For instance, many media posts provided by social media content providers inherently lack one or all of location information, topic information, author information, or other information that would be useful for a user of the service to understand the story told by the media post. Furthermore, this lack of information unnecessarily encumbers the search for relevant information and makes grouping related media posts inefficient.

It is appreciated that there is a need in the industry to differentiate, filter, and enhance social networking information (e.g., social media content or any content produced by a human otherwise known as “UGC” or user generated content), and other information based on parameters that are user determined, such as geographic location and/or content type. These and other shortcomings of the prior art are addressed according to various aspects of the present invention by providing systems and methods for enhancing and providing geographically delineated content. In one aspect of the invention, it is desired that a service be provided that enhances geographically delineated content with one or more enrichments. Enrichments supplement the story told by the geographically delineated content to provide a more robust narrative.

In various embodiments, individual media posts within aggregated geographically delineated content are associated with one or more profiles each having a compilation of enrichment data. Profiles provide a repository of enrichment data related to a particular dimension of one or more media post and may be automatically updated responsive to aggregating geographically delineated content. For example, an author profile may include a description of the characteristics of the author that generated a media post. In various embodiments, the author profile may be automatically updated responsive to aggregation of any media posts having information about the author. Accordingly, profiles provide immediate access to enrichment data that may be used to enhance aggregated content.

In various embodiments, enrichment data can include author information, location information, venue information, event information, image information, or any other information for enhancing a media post. In various embodiments, enriched aggregated geographically delineated content permits the identification and relation of media posts that would not have otherwise been related. It is appreciated that enrichments provide a more interconnected and organized aggregation of content. It is also appreciated that increased organization and interrelation between media posts and content provides for a more efficient and capable system. For example, media posts sharing a common profile, such as an author profile may be grouped. Groupings permit a user to view, interact, and filter content based on information not inherently contained in the content. For instance, conventional services do not permit a user to filter aggregated content based on an author influence level because this information is not provided by the content provider. Unfortunately, with such conventional services a user is required to parse through searched content to ascertain the relevant information. Such a process is wasteful and time consuming. In contrast, various embodiments as discussed herein, permit users to filter, group, view, or otherwise manage social media content based on more accurate information (i.e., enrichment data) associated with social media posts. Often this includes grouping media posts by content topic, photograph topic, author, hashtags, @mentions, impressions, or influence level. Notably, grouping and filtering may be performed automatically or at the request of the user. Accordingly, various embodiment discussed herein provide users with more accurate and relevant content.

Although associating user generated social media content with a geographic location is known, it would be beneficial to aggregate and enhance location based social media content from a plurality of providers. Aggregation and enhancement permits, for example, increased functionality over the functionality possible by using raw data generated by social media providers. For instance, enhancement of aggregated geographically delineated content permits the detection of one or more incongruities, such as trends. Trends permit a user to analyze or discover the source of social media tendencies. Furthermore, aggregation and enhancement of some social media content may permit accurate predictions based on historic and trend-based comparisons. As discussed above, conventional services are limited to returning the raw data generated by the content provider. Notably, this does not include the inspiration of the media posts, increases or decreases in a volume of the media posts, or the detection of any media posts associated with a geographic location that are outside of normal activity. In contrast, the enrichment data and embodiments described herein permit a user to view fluctuations or any incongruities in social media posts for a particular geographic location. This may be of particular value when detecting breaking news, identifying new customers, identifying highly influential authors of media posts, or forecasting social events.

Also, it is appreciated that the user, or client, benefits by having real-time access to more content, more relevant content, and detailed social media content across multiple social content provider platforms. Accordingly, users will receive more robust and interconnected aggregation of content. Various embodiments permit more efficient, swift, and detailed user queries to return more relevant content. It is appreciated that conventional systems are limited to distribution of the raw data provided by social media content providers and, accordingly, users may not receive all relevant information. Additionally, embodiments discussed herein may facilitate interaction with the enhanced geographically delineated content through one or more visualizations, such as, heatmap visualizations. Accordingly, the systems and methods described herein facilitate organization, interrelation, and analysis of geographically delineated content.

For example, the mass majority of media posts do not include a location reference. Therefore, conventional geographic based searches will miss the majority of media posts because the posts have no associated location to reference. Even if a media post does happen to include a location reference, there typically is not enough additional information to accurately identify a similarity between the media post and other media posts. Not only does this lead to aggregation of incomplete information, it can lead to misrepresentations of opinions, interests, or other information contained in the media posts of the majority. Furthermore, the omitted media posts may contain valuable information that could be economically or socially useful, such as breaking news stories, author opinions, or author interests. For example, only ten percent of Instagram impressions associated with a University may include a location reference, such as a hashtag, related to that university. This leaves ninety percent of the information undetectable and unsearchable. Undetectable information could be used by the University to monitor student activity on or off campus, engage students, provide customer service, manage student sentiments, detect security threats or alerts, and otherwise learn, react, promote, and republish the content.

Enriched aggregated geographically delineated content, as described herein, makes available this otherwise undetectable and unsearchable information. By enhancing aggregated content with enrichment data not inherent to the content, the one or more systems and processes described herein permit a user to “find” more content and “find” more relevant content for a desired location. Often this includes associating a media post with a location, but it may also include adding any other information necessary to efficiently and accurately relate the media post to other similar media posts. Accordingly, this provides the user with a more robust and detailed depiction of the social activity within a desired location. As discussed, the enriched aggregated content may be used monitor activity, detect alerts, provide alerts, provide customer service, republish media posts, engage with customers, research competitors, and detect breaking news, among other uses.

At least one aspect of the invention is directed to a computer system comprising a location-based service including a distributed computer system having at least one processor, a delineation component executable by the at least one processor and configured to query at least one social media content provider and aggregate geographically delineated content including a plurality of media posts each generated by an author, the content being received from the at least one social media content provider, a deconstruction component executable by the at least one processor and configured to automatically deconstruct individual media posts of the plurality of media posts into a plurality of dimensions, an enrichment component executable by the at least one processor and configured to: automatically aggregate enrichment data related to at least one of the dimensions of each of the individual media posts, the enrichment data including at least author profile information associated with an author profile of the author that generated the respective media post, and responsive to aggregating the enrichment data, enhancing the plurality of media posts with the enrichment data to generate enriched aggregated geographically delineated content, and a communication component configured to distribute the enriched aggregated geographically delineated content.

In one embodiment, the plurality of media posts includes at least social media content. In another embodiment, the system further includes an interface configured to receive an input identifying a geographic location, and wherein the delineation component is configured to query the at least one social media content provider responsive to receiving the input.

In accordance with one embodiment, the author profile includes a description of the characteristics of the author that generated the respective media post, the characteristics determined from a plurality of social media content providers. In a further embodiment, the author profile information includes one of author identification, author preferences, author interests, author sentiments, author influence, author connections, author activity, author gender, approximate author age range, and author local location. In a further embodiment, the author profile includes a queryable profile identifier and the system further comprises an author profile database configured to index the author profile respective to the author profile identifier. In another embodiment, the plurality of dimensions can include an author dimension and the enrichment component is further configured to analyze meta information associated with the author dimension of one of the plurality of media posts to realize the profile identifier of the author profile and query the profile database based on the realized profile identifier.

In one embodiment, the enrichment component is further configured to update the author profile responsive to aggregating geographically delineated content. In another embodiment, the plurality of dimensions include an image dimension and the enrichment component is further configured to analyze meta information associated with the image dimension of individual media posts of the plurality of media posts to determine enrichment data including at least one of a photograph topic, a photograph scene, a depicted logo, facial features, spam, and memes.

In accordance with one embodiment, the plurality of dimensions can further include a content dimension and the enrichment component is further configured to analyze meta information associated with the content dimension of individual media posts of the plurality of media posts to determine enrichment data including at least one of topics, keywords, hashtags, @mention, and social velocity. In a further embodiment, the enrichment component is further configured to cross-reference the content dimension of a first media post with one or more content dimensions of one or more additional media posts of the aggregated geographically delineated content. In still a further embodiment, the enrichment component is further configured to group related media posts responsive to cross-referencing the content dimension of the first media post with one or more content dimensions of one or more additional media posts.

In one embodiment, the plurality of dimensions includes a location dimension and the enrichment component is further configured to analyze one or more location references associated with the location dimension of individual media posts of the plurality of media posts to determine enrichment data including venue location, time, weather, precise location, and genuine location. In a further embodiment, analyzing one or more location references includes analyzing time stamps and associated locations of historic media posts of the author that generated the respective media post.

In accordance with one embodiment, the system further includes an enrichment database configured to store the enriched aggregated geographically delineated content. In another embodiment, the system further comprises a relation component executable by the at least one processor and configured to determine a heatmap visualization from the enriched aggregated geographically delineated content.

In accordance with another aspect of the invention, provided is a computer-executed method comprising acts of querying at least one social media content provider, aggregating geographically delineated content from the at least one social media content provider, the content being received from the at least one social media content provider and including a plurality of media posts each generated by an author, deconstructing, automatically, individual media posts of the plurality of media posts into a plurality of dimensions, aggregating, automatically, enrichment data related to at least one of the dimensions of each of the individual media posts, the enrichment data including at least author profile information associated with an author profile of the author that generated the respective media post, responsive to aggregating the enrichment data, enhancing the plurality of media posts with the enrichment data to generate enriched aggregated geographically delineated content, and distributing the enriched aggregated geographically delineated content.

In one embodiment, the plurality of media posts includes at least social media content. In another embodiment, the method further includes receiving an input identifying a geographic location, and wherein querying the at least one social media content provider is performed responsive to receiving the input.

In another embodiment, the author profile includes a description of the characteristics of the author that generated the respective media post, the characteristics determined from a plurality of social media content providers. In a further embodiment, the author profile information includes one of author identification, author preferences, author interests, author sentiments, author influence, author connections, author activity, author gender, approximate author age range, and author local location. In a further embodiment, the author profile includes a queryable profile identifier and the method further comprises indexing the author profile in an author profile database relative to the profile identifier. In still a further embodiment, the plurality of dimensions may include an author dimension and the method further comprises analyzing meta information associated with the author dimension of one of the plurality of media posts to realize the identifier of the author profile and querying the author profile database based on the realized profile identifier.

In one embodiment, the method further includes updating the author profile responsive to aggregating geographically delineated content. In another embodiment, the plurality of dimensions can include an image dimension and the method further comprises analyzing meta information associated with the image dimension of individual media posts of the plurality of media posts to determine enrichment data including at least one of a photograph topic, a photograph scene, a depicted logo, facial features, spam, and memes.

In accordance with one embodiment, the plurality of dimensions can further include a content dimension and the method further comprises analyzing meta information associated with the content dimension of individual media posts of the plurality of media posts to determine enrichment data including at least one of topics, keywords, hashtags, @mentions, and social velocity. In a further embodiment, analyzing content associated with the content dimension can include cross-referencing the content dimension of a first media post with one or more content dimensions of one or more additional media posts of the aggregated geographically delineated content. In a further embodiment, the method further includes grouping related media posts responsive to cross-referencing the content dimension of the first media post with one or more content dimensions of one or more additional media posts.

In one embodiment, the plurality of dimensions includes a location dimension and the method further comprises analyzing one or more location references associated with the location dimension of individual media posts of the plurality of media posts to determine enrichment data including venue location, time, weather, precise location, and genuine location. In a further embodiment, analyzing one or more location references can include analyzing time stamps and associated locations of historic media posts of the author that generated the respective media post.

In one embodiment, the method can further include storing the enriched aggregated geographically delineated content. In another embodiment, the method can further include determining a heatmap visualization from the enriched aggregated geographically delineated content.

At least one aspect of the invention is directed to a computer system including an interface configured to receive an input identifying a geographic location, a location-based service including a distributed computer system having at least one processor in data communication with the interface, a delineation component executable by the at least one processor and configured to: query at least one social media content provider and aggregate a first set of geographically delineated content including a plurality of media posts each generated by an author, the first set of content being received from the at least one social media content provider responsive to the received input, and query at least one social media content source and aggregate a second set of geographically delineated content including a plurality of media posts each generated by an author, the second set of content being received from the at least one social media content source, an enrichment component executable by the at least one processor and configured to enhance the first set and second set of aggregated geographically delineated content with enrichment data to generate an enriched first set of aggregated geographically delineated content and an enriched second set of aggregated geographically delineated content, and a trend component executable by the at least one processor and configured to detect an incongruity from a comparison of the enriched first set of aggregated geographically delineated content and the enriched second set of aggregated geographically delineated content.

In one embodiment, the plurality of media posts of the first and second set of aggregated geographically delineated content may include at least social media content. In another embodiment, the input may further include a first time frame for which to aggregate the first set of geographically delineated content and the delineation component can be further configured to aggregate the first set of geographically delineated content for the first time frame.

In one embodiment, the delineation component may be further configured to aggregate the second set of geographically delineated content at a second time frame temporally preceding the first time frame. In a further embodiment, the trend component may be further configured to detect an incongruity from a comparison of the enriched first set of aggregated geographically delineated content and the enriched second set of aggregated geographically delineated content from the first time frame to the second time frame.

In accordance with one embodiment, the incongruity can include a change in a volume of the plurality of media posts of the enriched first set of geographically delineated content and the plurality of media posts of the enriched second set of geographically delineated content from the first time frame to the second time frame. In another embodiment, the enrichment data may include author profile information associated with author profiles identifying the authors that generated the media posts of the plurality of media posts of the enriched first set of aggregated geographically delineated content and the enriched second set of aggregated geographically delineated content, and the incongruity may include a change in a volume of the authors identified by the author profile information of the enriched first set of aggregated geographically delineated content and the enriched second set of aggregated geographically delineated content from the first time frame to the second time frame.

In one embodiment, the author profile information may include an influence associated with the author profiles of the authors that generated the media posts of the plurality of media posts of the enriched first set of aggregated geographically delineated content and the enriched second set of aggregated geographically delineated content, and the incongruity includes the identification of an author having an influence above a predetermined threshold. In another embodiment, the enrichment data may include a venue associated with individual media posts of the plurality of media posts of the enriched first set and second set of geographically delineated content, and the incongruity may include a change in a volume of the plurality of media posts associated with the venue from the first time frame to the second time frame.

In one embodiment, the enrichment data may include an impression associated with individual media posts of the plurality of media posts of the enriched first set and second set of aggregated geographically delineated content, and the incongruity may include a change in a volume of the impressions between the enriched first set of geographically delineated content and the enriched second set of geographically delineated content from the first time frame to the second time frame. In another embodiment, the enrichment data may include an image identification associated with individual media posts of the plurality of media posts of the enriched first set and second set of aggregated geographically delineated content, and the incongruity may include a change in a volume of the image identifications between the enriched first set of aggregated geographically delineated content and the enriched second set of aggregated geographically delineated content from the first time frame to the second time frame.

In one embodiment, the system may further include a relation component configured to generate a visualization of the detected incongruity. In a further embodiment, the visualization may include a heatmap visualization having an image of the geographic location and a neighboring area geographically proximate the geographic location. In a further embodiment, the visualization may include one of a graph, chart, and table.

In one embodiment, the system may further include a communication component configured distribute the detected incongruity. In one embodiment, the at least one social media content source may include at least one social media content provider. In another embodiment, the at least one social media content source includes at least one enrichment database.

In accordance with one embodiment, the input further may include an alert condition that defines an alert parameter and the trend component is further configured to generate an alert responsive to determining that the alert condition has been satisfied. In one embodiment, the delineation component may be further configured to query at least one social media content source and aggregate a third set of geographically delineated content including a plurality of media posts each generated by an author, the third set of content being received from the at least one social media content source. In a further embodiment, the enrichment component may be further configured to enhance the third set of aggregated geographically delineated content with enrichment data to generate an enriched third set of geographically delineated content, and the trend component may be further configured to detect an incongruity from a comparison of the enriched first set of aggregated geographically delineated content, the enriched second set of aggregated geographically delineated content, and the enriched third set of aggregated geographically delineated content.

In accordance with another aspect of the invention, provided is a computer-executed method including acts of: receiving an input identifying a geographic location, querying at least one social media content provider responsive to the received input, aggregating a first set of geographically delineated content including a plurality of media posts each generated by an author, the first set of content being received from the at least one social media content provider responsive to the received input, querying at least one social media content source, aggregating a second set of geographically delineated content including a plurality of media posts each generated by an author, the second set of content being received from the at least one social media content source, enhancing the first set and second set of aggregated geographically delineated content with enrichment data to generate an enriched first set of aggregated geographically delineated content and an enriched second set of aggregated geographically delineated content, and detecting an incongruity from a comparison of the enriched first set of aggregated geographically delineated content and the enriched second set of aggregated geographically delineated content.

In one embodiment, the plurality of media posts of the first and second set of aggregated geographically delineated content may include at least social media content. In one embodiment, the input may further include a first time frame for which to aggregate the first set of geographically delineated content and aggregating the first set of geographically delineated content includes aggregating the first set of geographically delineated content for the first time frame. In a further embodiment, aggregating the second set of geographically delineated content may include aggregating the second set of geographically delineated content at a second time frame temporally preceding the first time frame.

In one embodiment, the incongruity may include a change in a volume of the plurality of media posts of the enriched first set of geographically delineated content and the plurality of media posts of the enriched second set of geographically delineated content from the first time frame to the second time frame. In a further embodiment, the enrichment data may include author profile information associated with author profiles identifying the authors that generated the media posts of the plurality of media posts of the enriched first set of aggregated geographically delineated content and the enriched second set of aggregated geographically delineated content, and the incongruity may include a change in a volume of the authors identified by the author profile information of the enriched first set of aggregated geographically delineated content and the enriched second set of aggregated geographically delineated content from the first time frame to the second time frame.

In a further embodiment, the author profile information may include an influence associated with the author profiles of the authors that generated the media posts of the plurality of media posts of the enriched first set of aggregated geographically delineated content and the enriched second set of aggregated geographically delineated content, and the incongruity may include the identification of an author having an influence above a predetermined threshold.

In one embodiment, the enrichment data may include a venue associated with individual media posts of the plurality of media posts of the enriched first set and second set of geographically delineated content, and the incongruity includes a change in a volume of the plurality of media posts associated with the venue from the first time frame to the second time frame. In one embodiment, the enrichment data may include an impression associated with individual media posts of the plurality of media posts of the enriched first set and second set of aggregated geographically delineated content, and the incongruity may include a change in a volume of the impressions between the enriched first set of geographically delineated content and the enriched second set of geographically delineated content from the first time frame to the second time frame.

In one embodiment, the enrichment data may include topics associated with individual media posts of the plurality of media posts of the enriched first set and second set of aggregated geographically delineated content, and the incongruity may include a change in a volume of the media posts associated with an individual topic between the enriched first set of aggregated geographically delineated content and the enriched second set of aggregated geographically delineated content from the first time frame to the second time frame. In one embodiment, the enrichment data may include an image identification associated with individual media posts of the plurality of media posts of the enriched first set and second set of aggregated geographically delineated content, and the incongruity may include a change in a volume of the image identifications between the enriched first set of aggregated geographically delineated content and the enriched second set of aggregated geographically delineated content from the first time frame to the second time frame.

In accordance with one embodiment, the method may further include generating a visualization of the detected incongruity. In one embodiment, the visualization may include a heatmap visualization having an image of the geographic location and a neighboring area geographically proximate the geographic location. In an additional embodiment, the visualization includes one of a graph, chart, and table.

In one embodiment, the method may further include distributing the detected incongruity. In one embodiment, the at least one social media content source may include at least one social media content provider. In another embodiment, the at least one social media content source may include at least one enrichment database.

In one embodiment, the input may further include an alert condition that defines an alert parameter and the method further comprises generating an alert responsive to determining that the alert condition has been satisfied. In one embodiment, the method may further include querying at least one social media content source and aggregating a third set of geographically delineated content including a plurality of media posts each generated by an author, the third set of content being received from the at least one social media content source. In a further embodiment, the method may further include: enhancing the third set of aggregated geographically delineated content with enrichment data to generate an enriched third set of aggregated geographically delineated content, and detecting an incongruity from a comparison of the enriched first set of aggregated geographically delineated content, the enriched second set of aggregated geographically delineated content, and the enriched third set of aggregated geographically delineated content.

At least one aspect of the invention is direct to a graphical user interface for providing geographically delineated content, the graphical user interface comprising a display on a computer system executed by at least one processor, wherein the graphical user interface is configured to: present, on the display of the computer system, an interface component configured to receive a user input identifying at least one geographic location and a first time frame for which to query at least one social media content provider and aggregate geographically delineated content, accept, on the display of the computer system, a user input identifying the at least one geographical location and the first time frame, wherein the input includes a series of delineations, and present, to the user on the display of the computer system, a visualization of enriched aggregated geographically delineated content associated with the at least one geographic location, wherein the enriched aggregated geographically delineated content includes a plurality of media posts each generated by an author, individual ones of the plurality of media posts each having enrichment data associated therewith, wherein the enrichment data includes at least author profile information associated with an author profile of the author that generated the respective media post.

In one embodiment, the geographically delineated content includes at least social media content. In another embodiment, the visualization of the enriched aggregated geographically delineated content can include a heatmap visualization defined by a volume of the enriched aggregated geographically delineated content. In a further embodiment, the heatmap visualization can further include an image of the at least one geographic location and a neighboring area geographically proximate the at least one geographic location, and a plurality of indicators disposed on the image, the indicators corresponding to discrete geographic points within the at least one geographic location.

In one embodiment, the graphical user interface is further configured to: receive a selection of one of the plurality of indicators, and present, to the user on the display of the computer system, a subset of the enriched aggregated geographically delineated content, wherein the subset of the enriched aggregated geographically delineated content is associated with the corresponding discrete geographic point of the indicator.

In accordance with one embodiment, the graphical user interface may be further configured to present, to the user on the display of the computer system, one or more groups of enriched aggregated geographically delineated content. In a further embodiment, the groups of enriched aggregated geographically delineated content further include a collage of photographs. In another embodiment, the groups of enriched aggregated geographically delineated content further include a plurality of media posts having shared enrichment data. In a further embodiment, the shared enrichment data includes one of a topic, a photographic topic, a photographic scene, a hashtag, a keyword, a @mention, an author profile, a venue, a genuine location, a precise location, and a depicted logo.

In one embodiment, enrichment data can further include at least one of content information, event information, venue information, location information, and image information. In another embodiment, the author profile can include a description of the characteristics of the author that generated at least one of the plurality of media posts, the characteristics determined from a plurality of social media content providers. In a further embodiment, the author profile information may include one of author identification, author preferences, author interests, author sentiments, author influence, author connections, author activity, author gender, and approximate author age range.

In one embodiment, the graphical user interface can be further configured to present, to the user on the display of the computer system, an influence level for each author profile associated with individual ones of the plurality of media posts. In another embodiment, graphical user interface may be further configured to present, to the user on the display of the computer system, a visualization of a detected incongruity, the incongruity detected from a comparison of the enriched aggregated geographically delineated content for the first time frame, and enriched aggregated geographically delineated content for a second time frame. In a further embodiment, the visualization of a detected incongruity includes heatmap visualization of a trend. In a further embodiment, the visualization of a detected incongruity includes a timeline.

In one embodiment, the detected incongruity may include a change in a volume of the plurality of media posts of the enriched aggregated geographically delineated content from the first time frame to the second time frame. In one embodiment, the detected incongruity may include a change in a volume of the plurality of media posts associated with a venue from the first time frame to the second time frame. In one embodiment, the detected incongruity may include a change in a volume of impressions from the first time frame to the second time frame. In one embodiment, the detected incongruity may include a change in a volume of the media posts associated with an individual topic from the first time frame to the second time frame.

In accordance with one embodiment, the graphical user interface may be further configured to receive an alert condition, wherein the alert condition defines at least one alert parameter, and present, to the user on the display of the computer system, enriched aggregated geographically delineated content responsive to a determination that the alert condition has been satisfied.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 is a block diagram showing an example process for providing geographically delineated content that uses services, as discussed herein;

FIG. 3 is a block diagram showing an example process for amending a user or client received input according to one embodiment of the present invention;

FIG. 4 shows an example computer system with which various aspects of the invention may be practiced;

FIG. 5 shows one or more dimensions of deconstructed individual media posts within aggregated geographically delineated content, as discussed herein'

FIG. 6 is a block diagram showing an example process for enhancing aggregated geographically delineated content;

FIG. 7A is a schematic depiction of a data flow for enhancing aggregated content according to various embodiments;

FIG. 7B is an additional depiction of a data flow for enhancing aggregated content according to various embodiments;

FIG. 8 is a block diagram showing an example process for aggregating enrichment data, according to various embodiments;

FIG. 9 is a block diagram showing an example process for cross-reference one or more dimensions of one or more media posts, according to various embodiments;

FIG. 10 is a block diagram showing an example process for detecting an incongruity, according to various embodiments;

FIGS. 11-14 are block diagrams showing example processes for detecting an incongruity;

FIG. 15A shows an example interface in which user or client input may be provided according to one embodiment of the present invention;

FIG. 15B shows an additional example interface in which user or client input may be provided according to one embodiment of the present invention;

FIG. 16 shows an example interface in which geographically delineated content may be displayed according to one embodiment of the present invention;

FIG. 17 shows an example interface in which a heatmap visualization may be displayed according to one embodiment of the present invention;

FIG. 18 show an example interface in which a user or client may manage identified geographic locations, according to one embodiment of the present invention;

FIG. 19 shows an example interface for displaying detected incongruities, according to one embodiment of the present invention;

FIG. 20 shows an example interface for displaying enriched aggregated geographically delineated content, according to one embodiment of the present invention;

FIG. 21 shows an additional example interface for displaying individual media posts of enriched aggregated geographically delineated content;

FIG. 22 shows an additional example interface for displaying author influence, according to one embodiment of the present invention;

FIG. 23A-B shows an example interface for displaying detected trends, according to one embodiment of the present invention;

FIG. 24 shows an example interface in which alert conditions may be entered, according to one embodiment of the present invention;

FIG. 25 shows an additional interface in which alert conditions may be entered, according to one embodiment of the present invention;

FIG. 26 shows an example interface for displaying an alert, according to one embodiment of the present invention; and

FIG. 27 is a block diagram showing an example process for displaying incongruities, according to various embodiments.

### DETAILED DESCRIPTION

Embodiments disclosed herein include services, application systems, applications, and methods for providing geographically delineated content. Geographically delineated content can include social media content or social networking information that is relevant to one or more geographic locations. In various embodiments, geographically delineated content includes a plurality of media posts (“posts”). Each post is respectively generated by an author, which may include a user or client, through a social media content provider. For example content can include text, photographs, videos, hyperlinks, audio files, among other data types. Content can be provided by one or more social media content providers, online repositories of information, or any other provider of location-based relevant content. Although social media content providers, as described herein, include social media platforms such as Twitter, Facebook, MySpace, LinkedIn, Pinterest, Foursquare, Yelp, Tripadvisor, and Tumblr, in further embodiments, providers can include any social media content provider as is understood in the art (including any media that is produced by a human (user generated content), which may not necessarily be considered social media content or platforms).

Content can be generated by any source of content such as social media platform users, companies, or any other source of social media content. Sources of content may permit an author to generate media posts including text, image content, hyperlinks, audio files, hashtags, likes, dislikes, @mentions, image content, tagged venues/places, and author information including: user age, user sex, user topic interests, and user domicile. For example, a media post may include a tweet having an avatar, a username, the author's name, a number of likes, the date of the media post, a photograph, and one or more hashtags.

In various aspects, geographic location, as used herein, can refer to a country, a state, a city, a neighborhood, a building, a venue, an address, coordinates such as longitude and latitude, or any other information descriptive of a location. Although geographic location as used herein includes a single geographic location, in various embodiments, geographic location can include a plurality or a series of locations. In various embodiments, the geographically delineated content includes an attached (“tagged”) geographic location.

As described above, in some embodiments this can include a “check-in” to particular locations, including venues such as businesses, retail locations, events, points of interest, or other locations. A check-in generally includes a process that identifies the author with a particular location at a given time, and may be recorded over time. In other embodiments, the geographically delineated content is automatically tagged with a geographic location. For example, geographically delineated content generated from a content provider device having a Global Positioning System (“GPS”) may automatically embed location information in the generated content.

In further embodiments, a social media platform may allow an author to manually enter location information. While some content providers may not provide a location with generated content, location may still be inferred from intrinsic information, such as metadata (e.g., metrics) associated with the content. It should be appreciated that geographically delineated content should not be limited to content tagged with a geographic location in any particular manner. Accordingly, it is appreciated that various media posts and types of content will not have location information inherently associated therewith. As such, conventional systems cannot search and provide such information by geographic location. According to one aspect of the present invention, a system may be provided that enhances such information to include additional information that can be inferred by analyzing other content that is determined to be related to the media post not having a geographic location.

### Location-Based Systems and Processes

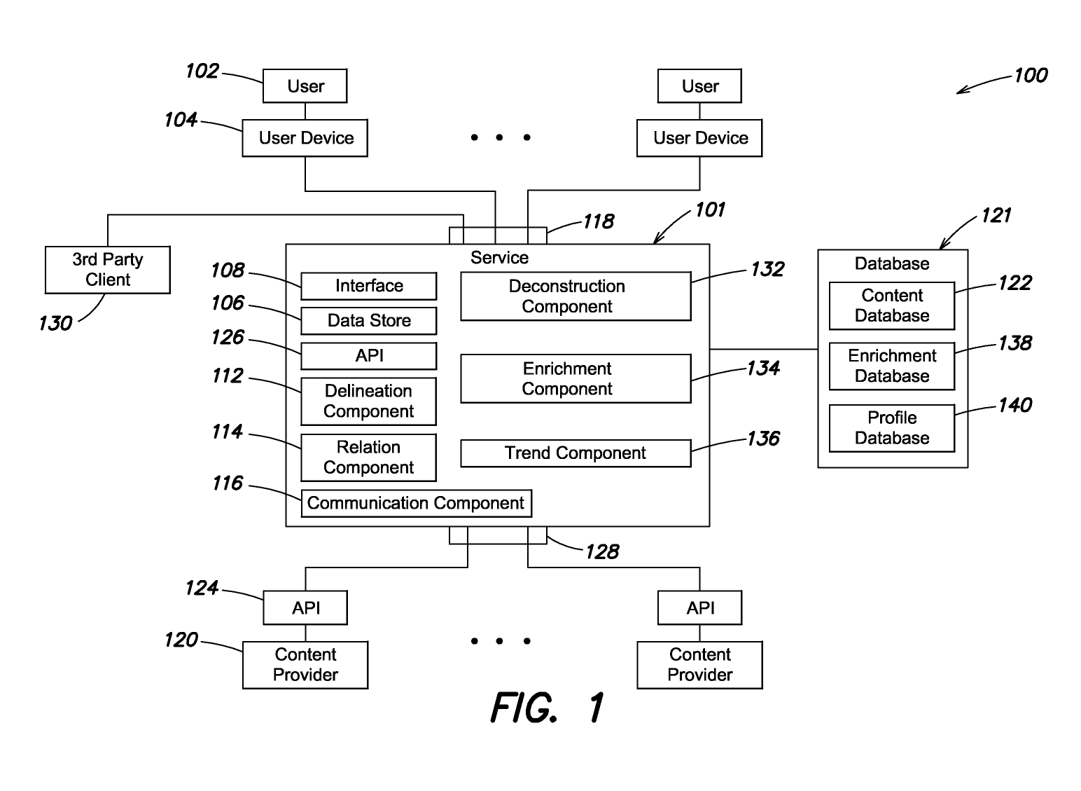

Turning now to FIG. 1, a block diagram of a location-based service and system suitable for incorporation of various aspects of the present invention is shown. For instance, the service 101 may permit one or more users (e.g., user 102) to request and receive geographically delineated content associated with the user's input identifying a geographic location. The entered location may be specified in the request for geographically delineated content. As shown, in one embodiment, the system can include a computing device (e.g., user device 104) having a memory, a user interface, and one or more processors. For example, the user device 104 can include a cell phone, smart phone, PDA, tablet computer, laptop, or other computing system. Users 102 may use the interface of the user device 104 for interacting with the system 100 to receive geographically delineated content. In other embodiments, the service may permit one or more third party client systems (e.g., client 130) to request and receive geographically delineated content associated with a client's input identifying a geographic location.

In one embodiment, the service may include one or more components. Such components may be implemented using one or more computer systems. In one embodiment, service 101 may be implemented on a distributed computer system using one or more communication networks (e.g., the Internet). In one implementation, the service is implemented in a cloud-based computing platform, such as the well-known EC2 platform available commercially from Amazon.com, Seattle, Wash. Other implementations are possible and are within the scope and spirit of the invention, and it is appreciated that other platforms may be used.

Service 101 may include a webserver which is capable of serving as a front end to the location-based service 101. User devices 104 and/or clients 130 may receive and display geographically delineated content aggregated and distributed by service 101. Notably, devices 104 and clients 130 may include controls that perform various functions in an application (e.g., a mobile application). Further, such devices 104 and clients 130 provide an input identifying a geographic location generated by the user 102 or the client. The user, or client, input may be used to perform one or more functions.

Service 101 may also provide one or more related services, such as a service for providing location-based social media content. Services may be integral to service 101 or may alternatively operate in conjunction with service 101 (e.g., by communicating with the service 101 through an Application Programming Interface (API)). In some implementations, the service 101 is configured to execute one or all of a plurality of components including a delineation component 112, a relation component 114, and a communication component 116.

The interface 108 of the service 101 is configured to receive from the user device 104, or the client 130, an input identifying or defining a geographic location. In various embodiments, the input includes a plurality of points, segments, arcs, edges or other delineations. For example, the input can include a polygon defined in a visual geographic representation of a geographic location identified by the user device 104 or client 130. The visual geographic representation can include a street map, a satellite image, a mass transit map, an image of at least one geographic location, or a schematic illustration of a detectable activity.

In an embodiment, the detectable activity comprises traffic on a website or mobile application. In this embodiment, the interface 108 is configured to provide a tool to permit the user or client to define the polygon. Tools can include, but should not be limited to, an expanding radius search, a bounding box search, and a customizable drawing tool, such as a cursor or mouse.

In further embodiments, the interface 108 is further configured to “snap close” or automatically complete an unfinished or incomplete polygon. In further embodiments, the interface 108 can be further configured to permit fine tuning adjustments of the input. For example, once the input is entered, the user or client may refine their input by making slight adjustments by pushing, pulling, or dragging the polygon that defines the geographic location. The user or client may do this by moving individual lines of the polygon, discrete points on the lines of the polygon, or “pushing” or “pulling” boundaries of the polygon.

In one embodiment, the user device 104 includes a touch display in communication with the one or more processors and configured to display a user requested visual geographic representation prior to identification of the geographic location (e.g., a map). For example, the user may request a map of Boston, Mass. prior to defining the polygon for which to request geographically delineated content. In one embodiment, user device 104 is configured to detect at the one or more processors an initialization of creation of the input, initialized by a first input event comprising a touch input on the touch display and detect at the processor a finalization of creation of the input, finalized by a second input event comprising the cessation of the touch input on the touch display. In an implementation the first touch input can include the user 102 touching the touch display, the user 102 touching the touch display with a single finger, or the user 102 contacting the touch display with a compatible article.

In some embodiments, the user device 104 is also configured to detect at the one or more processors an initialization of creation of a first input, initialized by a first input event comprising a touch input on the touch display, detect at the one or more processors a first finalization of creation of the first input, finalized by a second input event comprising the cessation of the touch input on the touch display, detect at the one or more processors an initialization of creation of a second input, initialized by a third input event comprising a touch input on the touch display, and detect at the one or more processors a second finalization of creation of the second input, finalized by a fourth input event comprising cessation of the touch input on the touch display. The second input can include, for example, an extension or amendment of the first input. In various embodiments, the second input includes a subtraction from the first created input. In some embodiments, the input includes one or, preferably, a plurality of touch points, or “nobs”, that are of greater size than the polygon, making touch input easier for a user. In various embodiments, a touch display includes an input device with an ability to display information, including a touch screen or touch pad, or a video screen that is able to capture movement, or facial or gesture recognition.

Although described herein as configured to provide tools that permit the user 102 to define a polygon on a geographic representation (e.g., map), in further embodiments, the user interface is configured to receive as a user input: a country, a state, a city, a neighborhood, a building, a venue, an address, coordinates such as longitude and latitude, or any other information descriptive of a location. For example, in one implementation the user 102 may enter “Boston, Mass.” to associate the user with the Boston geographic location, and to define the geographic location as the Boston area for which content may be requested.

In other embodiments, the input received by the interface 108 further includes one or more query parameters specifying the geographically delineated content requested. Accordingly, the user, or client, can specify the type or topic of geographic delineated content that is aggregated and provided by the service 101. For example, the interface 108 can be configured to receive an input consisting of “shoe sales in Boston, Mass.” After the user or client has satisfactorily entered the input, activation of a search indicator prompts the service 101 to aggregate and distribute geographically delineated content within the identified geographic location, omitting all content outside of the identified geographic location.

As another option, the user 102 may be permitted to narrow a search for content by specifying certain sources of content (e.g., with the user device 104). For example, the user 102 may be permitted to specify (e.g., via an interface control) the types of sources, or content, that should be included within the geographically delineated content. For instance, the user may specify only Twitter-generated content, or only social media posts including a photograph, among other content.

In some embodiments, the user or client input may be used to generate geographic delineated content. For example, the user device 104 can be configured to: i) detect at the processor on the device 104 an initialization of creation of content, initialized by a first input event comprising a touch input on the touch display through an application on the device 104, wherein the application is associated with geographical information viewable on or through the touch display; and ii) detect at the processor a finalization of creation of content, finalized by a second input event comprising the cessation of the touch input on the touch display, wherein the created content comprises delineated geographic content associated with social networking information. In various embodiments, the user device 104, is further configured to automatically display the social networking information on or through the touch display immediately following the cessation of the touch input and may also refresh the social networking information one or more times with one or more additional touch inputs.

Although described above as including touch displays, in various embodiments, the user device 104 can be configured to perform one or more processes in response to a click input. For example, the user device 104 can be configured to detect at the one or more processors an initialization of creation of the input, initialized by a first click event comprising a click input on a display and detect at the processor a finalization of creation of the input, finalized by a second click input event on the display.

In one embodiment, the service 101 may store information for each particular user or client, including inputs or preference information identifying location or geographically delineated content type. Specifically, after receiving the input at the interface 108, the user or client may activate a save indicator prompting the service 101 to store the entered input or returned geographic delineated content at a data store 106. In various embodiments, the user or client can label or otherwise “name” a polygon or geographic location specified in the input. Stored inputs can be associated with user accounts and recalled from the data store 106. For example, the service 101 can be configured to associate an entered input with a unique identifier associated with the user or client. The service 101 can then be configured to aggregate and distribute geographically delineated content relating to the unique identifier.

It is appreciated that users of the systems, methods, and services described herein may be interested in social media content generated at the same geographic location over periods of time, for example, a user 102, or client, may make the same request for geographically delineated content in the Boston, Mass. area three times a week. Accordingly, the service 101 permits the user 102, or client, to store entered inputs and defined geographic locations for efficiency and convenience purposes.

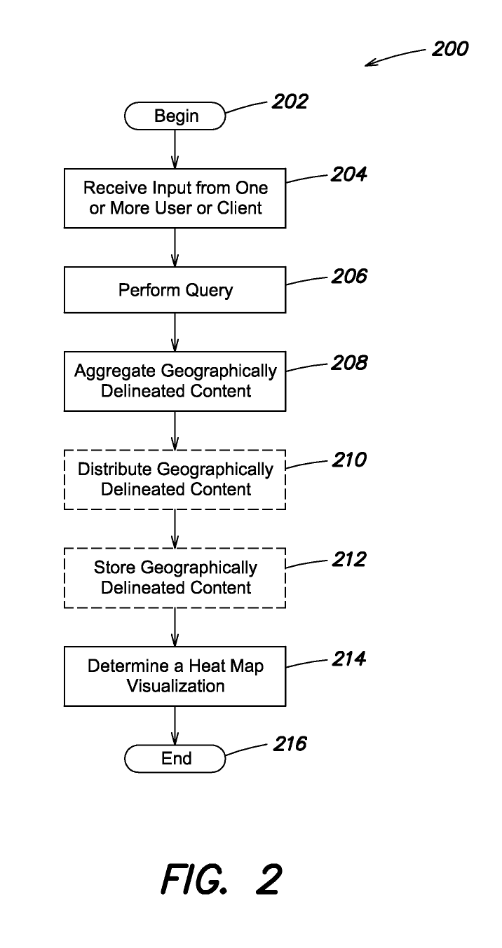

With continuing reference to FIG. 1, FIG. 2 shows an example process (e.g., process 200) for providing geographically delineated content in accordance with one embodiment. At block 202, the process 200 begins. At block 204 an input identifying one or more geographic locations is received from a user or a client, over a network 118. At block 204, a website or application (e.g., application executing on the user device 104) may be displayed to the user 102. Alternatively, an interface such as an API (e.g., API 126) may be provided to an application for providing the input to another application or system, such as the client 130. As discussed above, the input may be provided via one or more interfaces and received at the interface 108 of the service 101. Also, the input may be received from a third party application or system that utilizes location-based services.

At block 206, a component within the service 101 is configured to communicate with at least one content provider 120 through a network connection, e.g., network 128, and/or communicate with a geographically delineated content database, e.g., content database 122 to perform a query. As shown in FIG. 1, the system 100 may include a plurality of databases (e.g., enrichment database 138 and profile database 140 that are discussed in further detail below). In various embodiments, the service 101 is configured to store aggregated geographically delineated content partitioned within a shared database (e.g., database 121). As discussed above, the input received by the interface 108 further can include one or more query parameters specifying the geographically delineated content requested. Accordingly, the user or client can specify the type or topic of geographic delineated content that is aggregated and distributed.

In response to receiving the input, the delineation component 112 generates a query compatible with the one or more content providers 120, including at least the geographic location defined by user or client. For example, the query can be formatted to request geographic delineated content from one or more content provider APIs 124. The APIs 124 associated with one or more content providers 120 permit the exchange of geographic delineated content. However, in other various implementations the delineation component is configured to generate a query for the content provider without using an associated API. It is appreciated that various content provider APIs may have differing limitations and accordingly, in various implementations, the query is formatted specifically for each content provider.

In one embodiment, a content provider 120 is queried by specifying a geographic point, for example a longitude and latitude, and designating a radius around that point for aggregating geographically delineated content. Additionally, a time period, or other criteria, may be specified. Requested data is aggregated, received, and stored, for example, in short-term storage. Although described above as performing one query, in various embodiments the delineation component 112 is configured to perform multiple queries in response to receiving a client or user input. For example, the delineation component 112 can be configured to perform a second and a third query to ensure that all areas of the user or client defined geographic location are covered. At block 208, the delineation component 112 is configured to aggregate geographically delineated content from at least one social media content provider (e.g., content provider 120) based on the user or client input. In response to performing the query of block 206, the delineation component 112 receives and aggregates geographically delineated content from the one or more content providers 120. For example, aggregated content can include social media content having an associated geographic location. Content may be aggregated from one or a plurality of content providers 120, as discussed above, in one or a plurality of formats. Content can include text, photographs, videos, and/or audio files, and in additional embodiments, enrichments.

Although described above as configured to query one or more content providers and aggregate geographically delineated content in response to a user or client input, in other embodiments, the delineation component is configured to query one or more content providers and aggregate geographically delineated content automatically. In one embodiment, the delineation component is configured to continually query content providers for content relative to frequently requested geographic locations. For example, the delineation component 112 can be configured to automatically and continually query and aggregate geographically delineated content from Twitter in the Boston, Mass. geographic area. Automatic queries may be time scheduled, may be random, or may be variable based upon the activity within a particular geographic location. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

In some embodiments, the delineation component 112 is further configured to delay, postpone, or “put to sleep” automatic queries and aggregations. For example, the delineation component 112 may delay automatic queries and aggregations of geographically delineated content for infrequently requested geographic locations. In this regard, the service 101 can determine whether content requested from a particular location will likely be requested, and delay the query and aggregation if necessary. Delay, postponement, and “put to sleep” configurations permit the service 101 to allocate computing resources. Although discussed herein as performed by a delineation component 112, in various other embodiments, querying one or more content providers 120 and aggregating geographically delineated content may be performed by a plurality of components.

At block 210 (shown in ghost lines as optional), the communication component 116 is configured to distribute the aggregated geographically delineated content to the one or more user devices (e.g., user device 104) or clients (e.g., client 130) permitting the respective user or client to view the geographically delineated content. In further embodiments, the communication component 116 may also distribute user or client generated inputs or geographically delineated content to social networking sites or social media content providers. At block 212 (shown in ghost lines as optional), the service 101 may also be capable storing information in one or more content databases 122. For instance, the service 101 may be configured to store geographically delineated content (e.g., location based social media content) such as text, photographs, videos, and audio files aggregated from at least one content provider 120.

In one implementation, the aggregated content is stored in a geographic quadrant based storage grid. When visualized, the grid resembles a mesh placed over the planet, in which grid lines run parallel to longitude and latitude lines. Accordingly, aggregated geographic content is stored in location-based quadrants related to the tagged location of the content. In other embodiments, aggregated geographic content is stored in a time-based grid, in which aggregated content is stored based on the time the geographic content was generated by the content provider. In other embodiments, aggregated content can be stored in an aggregation-time-based grid, in which aggregated content is stored based on the time the geographic content was aggregated by the delineation component. In further embodiments, the aggregated content can be stored in a subject-based grid, in which aggregated content is stored based on the source or the type of the geographically delineated content (e.g., Twitter, Facebook, MySpace, LinkedIn, Pinterest, or Tumblr content). It should be appreciated that geographically delineated content can be stored in any other fashion as is suitable for geographically delineated content.

In various embodiments, one or more components of the service 101 are configured to automatically generate datum content responsive to receiving geographically delineated content from one or more content providers 120. For example, datum content may correspond with the source content of each individual media post within the received geographically delineated content. Datum includes a concentration of the bare minimum information necessary to support a search and analysis of stored geographically delineated content. For example, while full image meta data is stored in a source document, the associated datum document only contains a list of metrics, otherwise referred to as feature names, e.g., “author,” “sport,” etc. The datum content reduces the file size and concentrates contents of the datum document to permit the service 101 to efficiently and rapidly convert a query against the datum content and aggregate geographically delineated content. As understood, file size refers to the amount of space consumed by a file, such as a datum document. Typically, file size is measured in bytes. It should be appreciated that a prohibitively large number of media posts may be generated by multiple users of various social media content providers that could be retrieved by a particular service. Because of the large numbers of items that could be queried, viewed, etc., by a system, a more efficient method of working with such items may be necessary.

Additionally, maintaining a full set of source content, permits the service 101 to further analyze the source content, debug the process, and perform other maintenance operations. One or more components can additionally be configured to denormalize key information into the datum content to optimize queries and analysis, for example, author profile information including username, follower count, avatar, author bio, etc. Such an embodiment permits the service 101 to perform one or more of the aspects discussed below, such as detecting high influence authors or filtering geographically delineated content to temper historically abundant topics or users.

For example, a media post may include all of the information associated with a self-taken Instagram picture posted at Gillette Stadium in Foxborough, Mass. during a professional football game. Generation of the datum document (referred to herein also as story datum) can include analysis of the meta data, information, or other data associated with the post that may suggest the topics, sports, football, rugby, and soccer. However, only “sport” and “football” are included in the datum document, as rugby and soccer are not relevant to a professional football game. The datum document also includes “person”, as included in the picture were facial features.

The datum may also include hashtags, and location information. In one embodiment, the datum may include different types of location information that are indicative of the source of the location information or otherwise indicate how the location information should be used by the system. For instance, as referred to herein, the system may define and use genuine or precise location information. As used herein, genuine location refers to a referential geographic position, such as a venue or store location, and precise location refers to navigational positioning, such as GPS location or longitudinal and latitudinal coordinates. Accordingly, in this example, the datum would include genuine_location true and precise_location false. Because the picture was taken at Gillete Stadium, the genuine location is included, but the precise location is not.

Based on the foregoing, the media post may be included in all queries and analysis of geographic delineated content associated with the Gillete Stadium location. In various embodiments differentiating between genuine location and precise location can include or exclude media posts displayed in a heatmap. Omitting media posts not having a precise location for a heatmap visualization of an identified geographic location prevents the build-up of artificially inflated “hotspots” of content for a particular discrete point within the identified location. Although described herein generally as aggregating geographically delineated content responsive to querying a geographically delineated content database, in various embodiments, querying a database includes identifying a story datum document and converting the query to return source content including one or more media posts. Datum content may be stored in any manner as described herein, such as in a geographic quadrant based storage grid. It should be appreciated that some or all of this datum content and its functionality may be made available to one or more clients directly, or be provided to a third party system (e.g., via am API).

Although the communication component 116 as described above in one embodiment is configured to distribute geographically delineated content in response to aggregating content from a content provider 120, in some embodiments, the communication component 116 can be configured to distribute geographically delineated content from the content database 122. In one implementation, the delineation component 112 is configured to query the content database 122 in response to receiving an input from the user device 104 or the client 130.

In an embodiment where the content database 122 includes a geographic quadrant based storage grid, quadrants are accessed relative to the geographic location identified in the input. Quadrants can be accessed at different resolutions, depending on the scope of the user input. Geographically delineated content stored in the content database 122 is aggregated from quadrants that intersect/overlap the geographic location identified in the input. For example, an input identifying Boston, Mass. may overlap example quadrants 1, 2, and 3. Accordingly, the service 101 accesses example quadrants 1, 2, and 3 instead of content in an entire radius of the Boston area, which may inadvertently subsume irrelevant information, such as geographically delineated content from the Cambridge, Mass. area. As such, the service 101 can be configured to provide geographically delineated content from a content database 122 in response to receiving an input identifying a geographic location.

In other embodiments, the content database 122, may or may not include a portion of the geographically delineated content desired by the user 102, or the client. Accordingly, some embodiments include both querying and aggregating geographically delineated content from the content database 122 and the one or more content providers 120. In one implementation, the delineation component is configured to first query and aggregate geographically delineated content from the content database 122. In response to aggregating content from the content database 122, the component is further configured to query and aggregate non-duplicate geographically delineated content from the content providers 120.

At block 214, the relation component 114 may determine a heatmap visualization from the aggregated geographically delineated content. As used herein, one embodiment of a heatmap visualization refers to a volume-based geographically delineated content depiction of the geographic location identified in the input by the user or client. In one implementation, the heatmap visualization includes an image of a geographic location (e.g., a map). For example, the image may include a street map, a satellite image, a mass transit map, or a schematic illustration of a detectable activity.

The heatmap visualization may further include one or more indicators layered over the image of the geographic location. The indicators are configured to show the density of the volume of the geographically delineated content for a discrete spatial area, or a series of spatial areas, on the image and can include but should not be limited to colors, shapes, and images. In one implementation, the heatmap visualization shows a range of colors conveying the volume of social media content in the geographic location to help the user or client understand the geographic layout of social media content or activity. For example, a heatmap visualization for a user or client requested geographic location of Boston, Mass., may show a higher volume of Twitter content in the North End neighborhood than the South End or South Boston neighborhoods.

In some embodiments, the communication component 116 is further configured to distribute the heatmap visualization to the one or more user devices 104 or clients 130. In this regard, the user interface 108 permits interaction with the heatmap visualization. In particular, the interface 108 is configured to permit the display of geographically delineated content in response to selection of one of the plurality of indicators overlayed the image of the geographic location. In other embodiments, the user or client may engage with the heatmap by adjusting one or more filters. For example, filters may include map shape, time period, content source, content type (e.g., text, video, photo, etc.), hashtags, keywords, @mentions, image content (computer vision meta, topics) tagged venues/places, user age, user sex, user topic interest, user domicile, or user influence level. Additionally, in one embodiment, the heatmap visualization is determined in response to aggregating geographically delineated content for an identified geographic location over a period of time. Accordingly, heatmapped historical data permits users and clients to analyze trends and fluctuations in social media content.

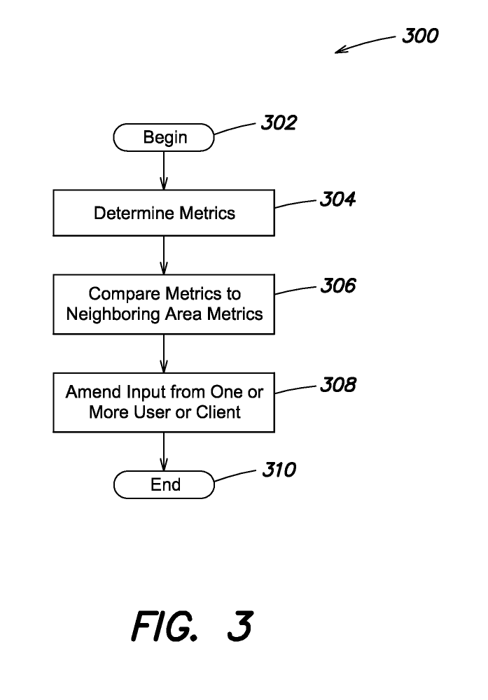

With continuing reference to FIG. 1 and FIG. 2, FIG. 3 shows an example process (e.g., process 300) for amending an input received from the user device 104 or client 130 in response to determining a heatmap visualization. For instance, one or more components of the service 101 may be configured to analyze the determined heatmap visualization and redefine the identified geographic location. Alternatively, one or more components of the service 101 may be configured to analyze the determined heatmap visualization and provide geographic location, social media content, or other heatmap based suggestions to the user or client. In one embodiment, the relation component 114 compares the volume of geographically delineated content in the indicated geographic location to the volume of geographically delineated content in a neighboring area geographically proximate the indicated location. Based on the comparison, the service 101 may automatically expand, shrink, move, or otherwise redefine the indicated geographic location to include or exclude geographically delineated content of the neighboring area.

The process 300 begins at block 302. At block 304, one or more component of the service 101, for example the relation component 114, is configured to determine metrics of the aggregated geographically delineated content. For example, metrics can include but are not limited to geographically delineated content provider, post source volume, content type hashtags, @mentions, geographic location, and computer vision meta data. In addition to the metrics, the service 101 is configured to implement machine intelligence to add enrichment data to the aggregated geographically delineated content. For instance, service 101 may be capable of automatically analyzing content as it is generated, such as by performing neuro-linguistic programming (“NLP”), or image processing including Computer Vision, to determine additional enrichment data that can be associated with the original content. In various implementations, enrichments include demographic information, topic detection, scene detection, logo detection, and facial recognition.

At block 306, one or more components, for example the relation component 114, is configured to determine metrics of content in the neighboring area geographically proximate the identified location. The neighboring area may be defined by a user or client entered value, e.g., 500 feet, or, set to a predetermined value. For example, the relation component 114 may begin by determining metrics of a neighboring area of the identified location (e.g., twice the size of the identified geographic location). In an embodiment, the relation component further compares the metrics of the indicated geographic location with the metrics of the neighboring area. For example, the relation component 114 can compare metadata to determine similarities and dissimilarities in the geographically delineated content. Similarities and dissimilarities may be used by component 114 to generate a relevancy score, for example.

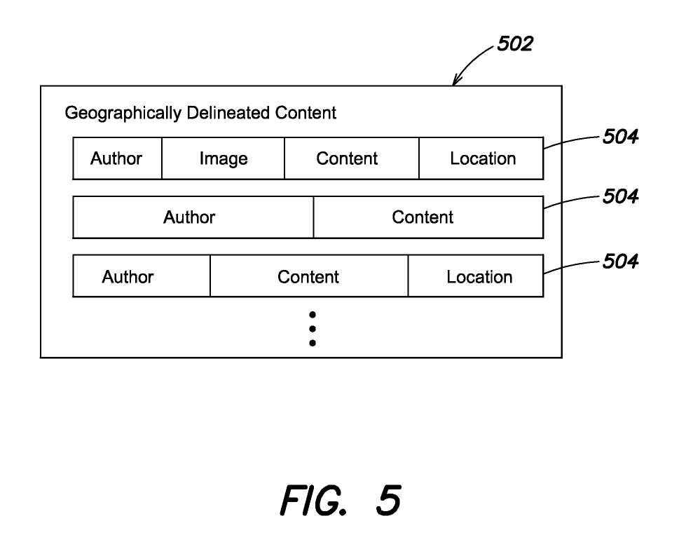

In other embodiments, the relation component 114 may further determine trends in the aggregated geographically delineated content based on the determined metrics. In one embodiment, metrics determined from the content of the geographic location and neighboring area over a time period may indicate that a topic or content subject is popular at a particular location at a specific time of year. For example, the metrics determined from geographic delineated content associated with the Symphony Hall venue in Boston, Mass. may show a strong correlation with the topic “Holiday Pops” during the months of November and December, whereas, metrics determined from the geographic delineated content may show a low correlation during the months of May and June. Accordingly, the relation component can be further configured to automatically redefine, or suggest a redefined input to the user or client, based on determined trends. Examples of enhancing aggregated geographically delineated content with enrichment data (e.g., metrics) is discussed in further detail below with reference to FIGS. 5-9.

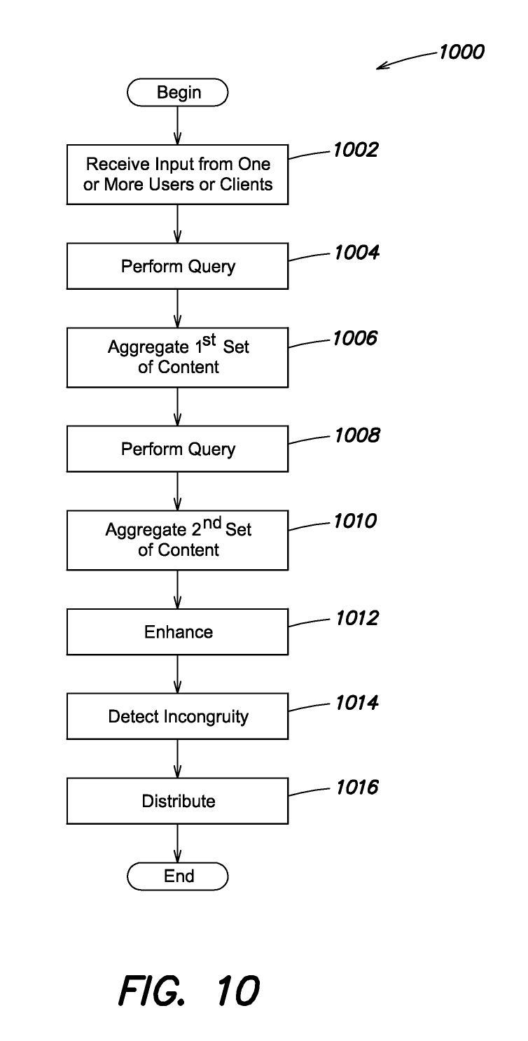

In some embodiments, the relation component 114 can be further configured to rank user or clients based, at least in part, on the relationship that their aggregated geographically delineated content are matched with other users. For example, users or clients may be ranked based on similarities or dissimilarities in metrics, geographic location, or identified preferences. Accordingly, the service 101 may additionally tailor aggregated geographically delineated content based on ranked similar users or clients. Detection of trends and incongruities in aggregated geographically delineated content is further described herein with reference to FIGS. 10-14.

At block 308, one or more component, for example the relation component 114, is further configured to amend the input from the user, or the client, in response to the comparison of the content metrics. In response to a “pocket” of similar matched metrics that is outside the bounds of the identified geographic location, the relation component maybe configured to automatically redefine the geographic location or suggest an amended input to the user or client. Accordingly, automatically redefined, or suggested redefined inputs, provides a user or client with a tailored and more robust aggregation of geographically delineated content. It is appreciated that tailored aggregations of geographically delineated content are efficient from an economic and computing perspective, while remaining informationally robust. The service 101, as described herein, permits a user, or client, to include social media “hotspots” that they may have missed, or that fall outside of their original input.

### Example Computing Device Implementations

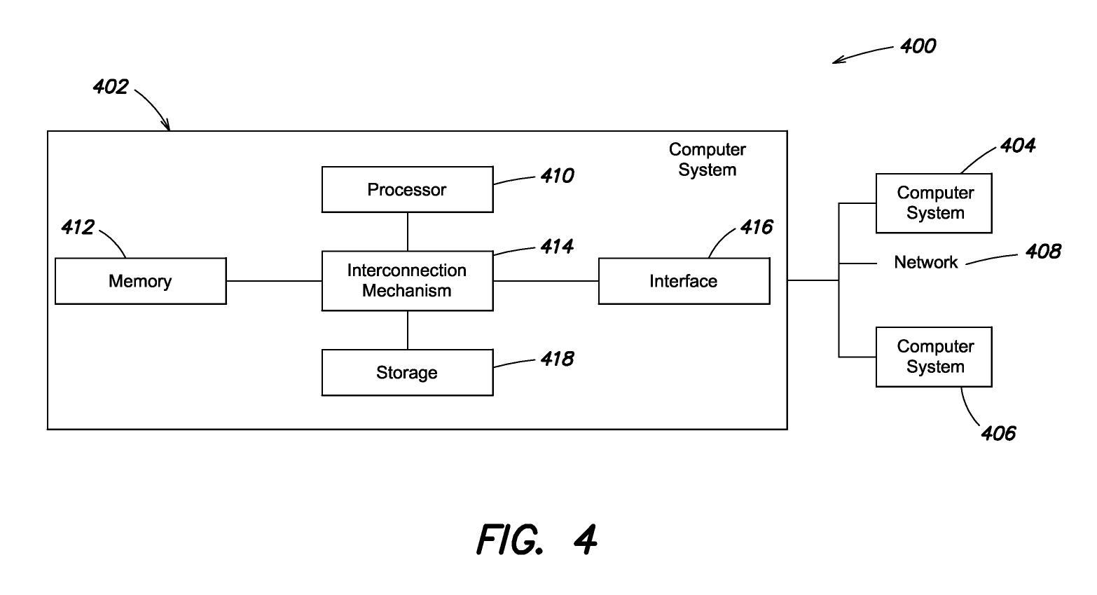

Referring to FIG. 4, there is illustrated a block diagram of a distributed computer system 400, in which various aspects and functions are practiced. As shown, the distributed computer system 400 includes one or more computer systems that exchange information. More specifically, the distributed computer system 400 includes computer systems 402, 404, and 406. As shown, the computer systems 402, 404, and 406 are interconnected by, and may exchange data through, a communication network 408. The network 408 may include any communication network through which computer systems may exchange data. To exchange data using the network 408, the computer systems 402, 404, and 406 and the network 408 may use various methods, protocols and standards to communicate information, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 402, 404, and 406 may transmit data via the network 408 using a variety of security measures including, for example, SSL or VPN technologies. While the distributed computer system 400 illustrates three networked computer systems, the distributed computer system 400 is not so limited and may include any number of computer systems and computing devices, networked using any medium and communication protocol.

As illustrated in FIG. 4, the computer system 402 includes a processor 410, a memory 412, an interconnection element 414, an interface 416 and data storage element 418. To implement at least some of the aspects, functions, and processes disclosed herein, the processor 410 performs a series of instructions that result in manipulated data. The processor 410 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 410 is connected to other system components, including one or more memory devices 412, by the interconnection element 414.

The memory 412 stores programs (e.g., sequences of instructions coded to be executable by the processor 410) and data during operation of the computer system 402. Thus, the memory 412 may be a relatively high performance, volatile, random access memory such as a dynamic random access memory (“DRAM”) or static memory (“SRAM”). However, the memory 412 may include any device for storing data, such as a disk drive or other nonvolatile storage device. Various examples may organize the memory 412 into particularized and, in some cases, unique structures to perform the functions disclosed herein. These data structures may be sized and organized to store values for particular data and types of data.

Components of the computer system 402 are coupled by an interconnection element such as the interconnection element 414. The interconnection element 414 may include any communication coupling between system components such as one or more physical busses in conformance with specialized or standard computing bus technologies such as IDE, SCSI, PCI and InfiniBand. The interconnection element 414 enables communications, including instructions and data, to be exchanged between system components of the computer system 402.

The computer system 402 also includes one or more interface devices 416 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 402 to exchange information and to communicate with external entities, such as users and other systems.

The data storage element 418 includes a computer readable and writeable nonvolatile, or non-transitory, data storage medium in which instructions are stored that define a program or other object that is executed by the processor 410. The data storage element 418 also may include information that is recorded, on or in, the medium, and that is processed by the processor 410 during execution of the program. More specifically, the information may be stored in one or more data structures specifically configured to conserve storage space or increase data exchange performance.

The instructions may be persistently stored as encoded signals, and the instructions may cause the processor 410 to perform any of the functions described herein. The medium may, for example, be optical disk, magnetic disk or flash memory, among others. In operation, the processor 410 or some other controller causes data to be read from the nonvolatile recording medium into another memory, such as the memory 412, that allows for faster access to the information by the processor 410 than does the storage medium included in the data storage element 418. The memory may be located in the data storage element 418 or in the memory 412, however, the processor 410 manipulates the data within the memory, and then copies the data to the storage medium associated with the data storage element 418 after processing is completed. A variety of components may manage data movement between the storage medium and other memory elements and examples are not limited to particular data management components. Further, examples are not limited to a particular memory system or data storage system.

Although the computer system 402 is shown by way of example as one type of computer system upon which various aspects and functions may be practiced, aspects and functions are not limited to being implemented on the computer system 402 as shown in FIG. 4. Various aspects and functions may be practiced on one or more computers having a different architectures or components than that shown in FIG. 4. For instance, the computer system 402 may include specially programmed, special-purpose hardware, such as an application-specific integrated circuit (“ASIC”) tailored to perform a particular operation disclosed herein. In another specially-designed system, both hardware and software may be used to provide a new tool that performs one or more aspects of the present invention. Another example may perform the same operation using a grid of several general-purpose computing devices running MAC OS System X with Intel processors and several specialized computing devices running proprietary hardware and operating systems.

The computer system 402 may be a computer system including an operating system that manages at least a portion of the hardware elements included in the computer system 402. In some examples, a processor or controller, such as the processor 410, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 410 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Example Enrichment Systems and Methods

Returning to FIG. 1, wherein a block diagram of a location-based service and system suitable for incorporation of various aspects of the present invention is shown, in various embodiments the service may aggregate enrichment data and enhance a plurality of media posts within geographically delineated content aggregated from one or more content providers. For instance, the service may permit one or more users (e.g., user 102) to request and receive enriched aggregated geographically delineated content associated with the user's input identifying a geographic location. Users may operate the interface of the user device 104 to interact with the system 100 to receive enriched aggregated geographically delineated content. In other embodiments, the service may permit the one or more third party client systems (e.g., client 130 shown in FIG. 1) to request and receive enriched aggregated geographically delineated content associated with the client's input identifying a geographic location.

It is appreciated that enriched aggregated geographically delineated content benefits the user, or client, by permitting real-time access to more content, more relevant content, and detailed social media content across multiple social content provider platforms. Accordingly, users receive more robust and interconnected aggregation of content. Various embodiments also permit more efficient, swift, and detailed user queries to return more relevant content. For example, often media posts received from Twitter will not include a location. In various embodiments, enrichment data including location information may be associated with the Twitter post. As such, users not only receive more detailed information, they will receive content that would not have otherwise been detected or found.

Service 101 may also provide one or more related services, such as a service for enhancing aggregated geographically delineated content to generate enriched aggregated geographically delineated content. Such services may be integral to service 101 or may alternatively operate in conjunction with service 101 (e.g., by communicating with the service 101 through an Application Programming Interface (API)). In some implementations, the service 101 is configured to execute one or all of a plurality of components including the delineation component 112, the relation component 114, and the communication component 116, discussed above, and a deconstruction component 132 and an enrichment component 134. One or more of the components shown in FIG. 1 are configured to enhance aggregated geographically delineated content. In one embodiment, enhancing aggregated geographically delineated content includes enhancing individual media posts within a plurality of media posts of the aggregated geographically delineated content. This may entail deconstructing individual media posts of the plurality into a plurality of dimensions and aggregating enrichment data related to each dimension.

FIG. 5 offers a visual representation of the one or more dimensions of deconstructed individual media posts 504 within the aggregated geographically delineated content 502. For example, dimensions may include an author dimension, an image dimension, a content dimension, and a location dimension. Other dimensions not shown may include a raw data dimension and an event dimension. It should be appreciated that media posts 504 may be deconstructed into various other dimensions not shown in FIG. 5 or discussed herein. Generally, dimensions include divisions of information, data, and meta information intrinsic to the media post 504. In various embodiments, media posts 504 are deconstructed based on the type of information intrinsic to the media post 504. For example, the author dimension of a media post 504 may include an avatar and a username of the author that generated that media post 504. Similarly, an image dimension may include a photograph. As shown in FIG. 5, each individual media post 504 may have one or more dimensions and all posts 504 within the aggregated geographically delineated content 502 may not have the same dimensions.

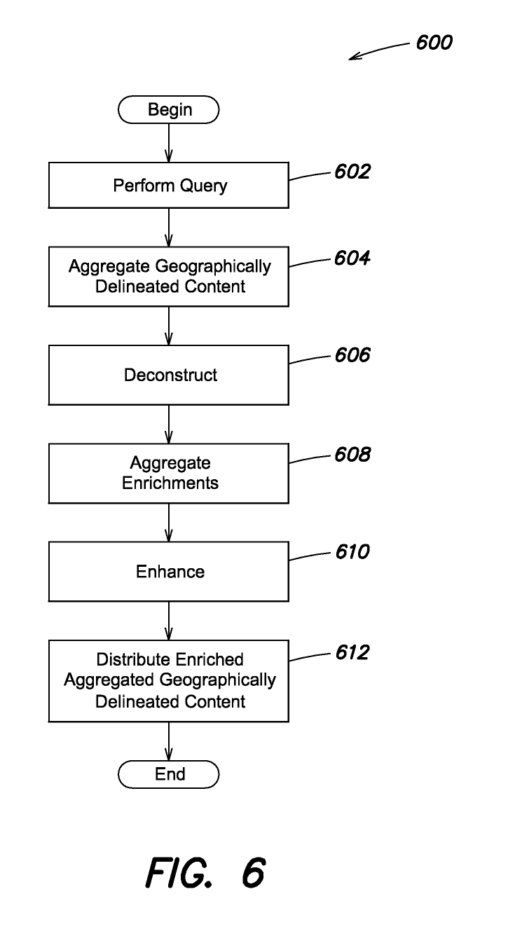

As described above, several embodiments perform processes that enhance aggregated geographically delineated content. In some embodiments, these processes are executed by a service, such as service 101 described above with reference to FIG. 1. One example of such a process is illustrated in FIG. 6. In block 602, a component within the service 101 is configured to communicate with at least one content provider (e.g., content provider 120 shown in FIG. 1) through a network connection, e.g., network 128, and/or communicate with a database, e.g., database 121 to perform a query. As discussed above, in one embodiment, input received from the user or client by the interface 108 further can include a geographic location and one or more query parameters specifying the geographically delineated content requested. Accordingly, the user or client can specify the type or topic of geographic delineated content that is aggregated and distributed.

In response to receiving the input, the delineation component 112 generates a query compatible with the one or more content providers 120, including at least the geographic location defined by the user or client. For example, the query can be formatted to request geographic delineated content from one or more content provider APIs 124. The APIs 124 associated with one or more content providers 120 permit the exchange of geographic delineated content. Such processes are described above with reference to block 206 of FIG. 2.

One or more components of the service 101 are configured to aggregate geographically delineated content in response to a user or client input (shown as block 604). Such a process is described in detail above with reference to block 208 of FIG. 2. In various other embodiments, the delineation component is configured to query one or more content providers 120 and aggregate geographically delineated content automatically. In further embodiments, the delineation component 112 is configured to continually query content providers 120 for content relative to frequently requested geographic locations. Automatic queries may be time scheduled, may be random, or may be determined by other methods (e.g., based on content-generating activity). In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

Turning now to block 606, in various embodiments, one or more components of the service 101 are configured to automatically deconstruct individual media posts of the plurality of media posts of the aggregated geographically delineated content. In one implementation, posts are deconstructed into a plurality of dimensions. For example, in one embodiment, deconstruction may be executed by a deconstruction component 132 operating in the service 101. The deconstruction component 132 can be configured to execute a predetermined series of algorithms and rules that determine the quantity and types of dimensions in to which to deconstruct an individual media post. For example, dimensions may include an author dimension, an image dimension, a location dimension, and/or a content dimension. Dimensions may further be divided by the deconstruction component 132 into a plurality of sub-dimensions. Sub-dimensions can include further divisions of a dimension. For example, in one embodiment the content dimension can include sub-dimensions including text, references, and/or keywords. In another example, a raw data dimensions may be divided into an image sub-dimension. As discussed herein, each dimension or sub-dimension corresponds to information, data, meta data, or meta information associated with a media post. It is appreciated that the dimensions of each individual media post within the plurality of media posts of the aggregated geographically delineated content may not be the same across all posts within the aggregated geographically delineated content.

At block 608, responsive to deconstructing the plurality of media posts, one or more components of the service may be configured to automatically aggregate enrichment data related to at least one of the dimensions of each of the individual media posts. In various embodiments, aggregating enrichment data includes analyzing the dimensions of each individual media post. In particular, the enrichment component 134 can be configured to realize an identifier associated with a profile having enrichment data. For example, in various embodiments this may include realizing and querying an author profile, a content profile, a location profile, or an event profile. Enrichment data can include author profile information, venue information, content information, location information, event information, or any other information not provided by the content provider from which the media post is provided (discussed below).

Turning to block 610, responsive to aggregating enrichment data related to at least one of the dimensions of each of the individual media posts, one or more component, such as the enrichment component 134, can be configured to enhance the plurality of media posts with the enrichment data to generate enriched aggregated geographically delineated content. As discussed herein, enhancing at least one of the individual media posts includes adding, exposing, identifying, or otherwise providing information, data, meta data, or meta information not inherent to the associated media post. It is appreciated that often a content provider 120 will not provide a full story associated with a media post. For example, in various embodiments, enhancing the plurality of media posts includes providing a visualization of enrichment data to present a more robust narrative of the story told by the media post. Enhancing the plurality of media posts, can include providing additional data related to at least one of an author dimension, a content dimension, a location dimension, or an image dimension. In further embodiments, enhancing the aggregated geographically delineated content with enrichment data permits the service to categorically group related media posts that would not have otherwise been identified as related.

At block 612, one or more components, such as the communication component 116, are configured to distribute the enriched aggregated geographically delineated content. For example, the communication component 116 may be configured to distribute the enriched aggregated geographically delineated content to the one or more user devices (e.g., user device 104 discussed above) or clients (e.g., client 130 discussed above) permitting the respective user or client to display and view the enriched aggregated geographically delineated content. Distribution of content is described in detail above with reference to block 210 of FIG. 2.

It should be appreciated that although FIG. 6 shows one embodiment of a process for managing content, it should be appreciated that other methods for processing content may be possible. For example, aggregation of content need not be performed responsive to a query (e.g., a feed may be received for a particular location on a regular or scheduled basis). Further enrichment of geographically delineated content may occur at any point in time, such as when it is received, when a related potion is received, on a scheduled enrichment schedule, or other time period.

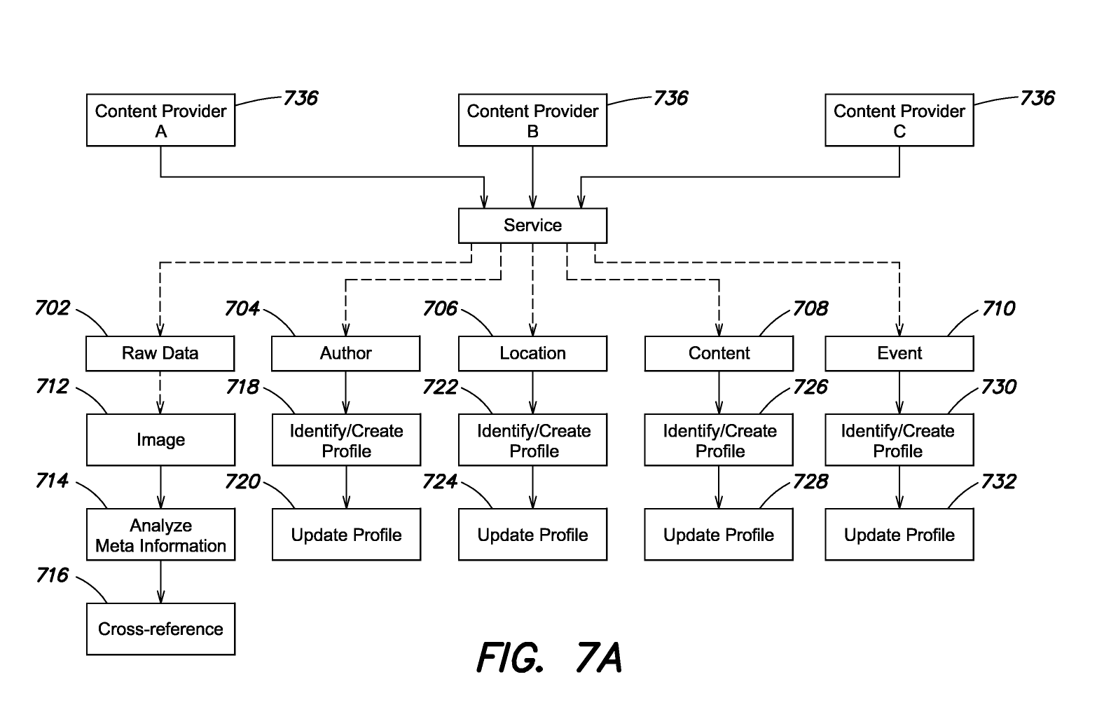

As described with reference to FIG. 6, several embodiments perform processes that enhance aggregated geographically delineated content. Often this includes enhancing individual media posts within the aggregated geographically delineated content with enrichment data. In some embodiments these processes are executed by a service, such as the service 101 described above with reference to FIG. 1. FIG. 7A shows a schematic depiction of the data flow for enhancing aggregated content according to various embodiments.

FIG. 7A shows a data process flow illustrating the deconstruction of individual ones of a plurality of media posts from a plurality of content providers 736 (content providers A, B, and C) into a raw data dimension (block 702), an author dimension (block 704), a location dimension (block 706), a content dimension (block 708), and an event dimension (block 710). In various embodiments, deconstructing a media post into a raw data dimension includes deconstructing the media post into an image dimension (block 712). While shown as deconstructed in a raw data, an author, a location, a content, and an event dimension, in various embodiments, individual media posts may be divided into one, two, or any number of the dimensions shown. Furthermore, the plurality of dimensions may include additional dimensions not shown in FIG. 7A. Dimensions permit the service 101 to efficiently analyze media posts and relate posts having similar information.

In one embodiment, enrichment data includes author profile information associated with an author profile of the author that generated the respective media post. Author profiles include a description of the characteristics of the author that generated the respective media post. Author profiles may be stored in one or more databases, such as a profile database (shown as 140 in FIG. 1). In one embodiment, responsive to aggregating geographically delineated content, one or more components of the service 101 are configured to analyze the author dimension of each of the plurality of media posts and determine an author responsible for generating the media post. This can include analyzing any of an avatar, a username, a full name, a bio, a profile picture, or any other characteristic available in a media post or on an author's profile at a social media content provider platform.

Responsive to identifying the author, a corresponding author profile can be identified (block 718), and profile information not included in the media post may be aggregated and applied to enrich the media post. For example, a media post within the plurality may include the author's name and avatar. While helpful, this information is limited and does not provide a full story about the author. Accordingly, aggregating enrichment data can include aggregating the author's date of birth, the school that the author attended, the author's interests, the author's relationship status, gender, age range, local location, recent activity, mutual connections, general activity, or any other author profile information from the stored author profile. As such, enrichments associated with author profile information provide the end recipient of the enriched aggregated geographically delineated content with a more robust aggregation of content by further describing the author that generated an individual post within the aggregated geographically delineated content. For example, detailed author information can be used to group author's having related interests, mutual connections, or any other shared information. In various embodiments, mutual connections may include first or second degree connections. As a result of the abundance of enrichment data that an author profile may have, acquaintances of the author's acquaintances can be detected as a second degree connection. Coupled with a geographic location, this content may be used to connect one or more authors.

In one embodiment, author profile information may include impressions associated with individual media posts of the author. Impressions include a measurement of the amount a media post is viewed. For example, this can include organic impressions (number of times a media post was accessed in a social media content provider's user profile), paid impressions (number of times paid content was viewed), or viral impressions (number of times a social media post was displayed or accessed in a second social media post). For example, viral impressions can include: liking, sharing, re-tweeting, commenting, responding to an event, or answering questions. Impressions may be used to enrich individual media posts, or a group of media posts, as a whole. Generally, impressions quantify the ability of the author to expose content to others. As such, enrichment data including impressions may additionally be analyzed to determine an influence level enrichment associated with the author profile.

In a further embodiment, author profile information may include an influence level (also referred to herein as “influence”). Influence levels associated with each individual author profile indicate the ability of the author to drive other authors or compel activity. For example, influence level may be based on the number of followers, the number of friends, number of re-tweets, amount of comments received, characteristics of friends or followers, or any other activity of the author. In particular, the influence level of one embodiment may be based on the number of followers, the number of authors being followed, the total amount of media posts, the amount of media posts aggregated by the service 101, and the amount of impressions (discussed above). Accordingly, the foregoing can be weighted and analyzed to determine an author influence level ranging on a scale from 1 to 4. A scaled influence of 4 indicates that the author has a strong ability to influence other authors or compel activity, and a scaled influence of 1 indicates the opposite. As such, influence level enrichments can be used to further enhance aggregated geographically delineated content. In one embodiment, author profile information including influence level includes a visual depiction of the influence level.

In various embodiments, no author profile may exist for an author associated with a media post. Often this is the case when a new author is identified. Accordingly, various embodiments include creating an author profile (additionally shown as block 718). Author profiles are generated by aggregating information, data, meta data, and information descriptive of author characteristics. As described above, characteristics can be ascertained from an author dimension of one or more media posts or a corresponding profile at one or more social media content provider platforms. For example, content providers may include social media and social networking providers such as Twitter, Facebook, MySpace, LinkedIn, Pinterest, Foursquare, Yelp, Tripadvisor, and Tumblr.

The characteristics may be arranged and stored as the author profile. For example, in various embodiments, responsive to identifying an author, the service 101 is configured to query one or more social media content providers 120 to determine an avatar, profile photograph, username, full name, bio, website, location, date joined, verification status, activity, number of followers, favorites, education, sentiments, connections, age, employment status, employer, relationship status, date birth for the author, gender, or any other author identifying characteristics for the author. The determined characteristics are added to the information ascertained from the author dimension of the media post and stored in the author profile accordingly. In various embodiments, one or more components of the service described herein are configured to update the author profile with each media post received (shown as block 720). For example an update may occur when a media post indicates that an author's interests have changed. Furthermore, author profiles may be updated responsive to detecting new characteristics at a user profile on a social media content provider platform. Updates may be performed automatically to ensure accurate and truthful author profile information aggregated from the author profiles. Notably, the author profile provides a centralized repository of author profile information available across all social media content providers. Because an original author can be identified across multiple social media platforms, social activity of the author may be more effectively measured in comparison to measuring activity over a single channel (e.g., Twitter).

Furthermore, in some implementations, a media post of the plurality of media posts may not have an author dimension associated therewith. Accordingly, one or more component of the service 101 may be configured to analyze the dimensions associated with the media post not having an author dimension to determine the author profile associated with the author. For example, in various embodiments the enrichment component is configured to analyze text within a content dimension to determine a name, or other identification of the author. For example, such an identification may include an @mention. Furthermore, the enrichment component 134 may be configured to analyze a photograph within an image dimension to determine facial features of the author. As such, in various embodiments one or more components are configured to analyze information, data, metadata, or meta information associated with the one or more dimensions of the plurality of media posts of the aggregated geographically delineated content to identify an author profile and aggregate enrichment data, such as author profile information.

With continuing reference to FIG. 7A, in one embodiment, enrichment data can include image information such as an image identification including a photograph topic, a photograph scene, a depicted logo, facial features, or spam, or memes. As used herein, memes may include any cultural item including image, video, or phrase that is transmitted by replication. As discussed above, in various embodiments one of more of the dimensions of a media post can include an image dimension. The image dimension is shown in FIG. 7A as a sub-dimension of a raw data dimension (block 702). As used herein, raw data refers to primary data collected from a source, such as the content providers 120, that has not been processed or otherwise filtered. The image dimension may include any information associated with an image in an individual media post of the plurality of media posts of the aggregated geographically delineated content. For example, in one embodiment, the media post may include a Twitter post having a photograph associated therewith. Accordingly, an image dimension of the Twitter post includes the photograph.

While the photograph may include some descriptive information, it does not tell the complete story of the media post. Accordingly, in various embodiments, aggregating enrichment data can include analyzing meta information associated with the image dimension (e.g., photograph) of the media post (shown as block 714). In various embodiments, analyzing meta information includes executing computer vision to determine a topic of the photograph, a scene of the photograph, a logo depicted in the photograph, or facial features of a person depicted in the photograph, whether the media post is spam, or whether the post includes a meme. Each of the foregoing is enrichment data not readily accessible in the raw data provided by a content provider. Furthermore, enhanced media posts may be cross-referenced with additional media posts within the aggregated geographically delineated content. Cross-referencing reveals similarities in topic of the photograph, scene of the photograph, depicted logo, or facial features (block 716), and can be used to group related media posts.

In various embodiments, performing computer vision includes determining whether or not the photograph includes certain features, objects, or activities. This may include recognition, identification, or detection of predetermined objects. In various embodiments, one or more components of the service 101 are configured to perform a series of algorithms for edge detection, blob counting, middle mass, image correlation, facial recognition, stereo vision, or other processing functions. For example, edge detection includes location of the edges of objects depicted in the photograph. In other examples, one or more components may be configured to approximate facial features depicted in a photograph as a linear combination of base images. Such an approach may also be applied to individual parts of the face (e.g., eyes, mouth, nose, etc.). While described herein as performed by one or more components of the service 101, in alternative embodiments, computer vision may be performed by one or more third party clients through associated APIs.

With continuing reference to FIG. 7A, in one embodiment, enrichment data includes content information including topics, keywords, hashtags, or @mentions, among other information. As discussed above, the one or more dimensions of a media post may include a content dimension (block 706). The content dimension can include any information associated with the content of an individual media post of the plurality of media posts of the aggregated geographically delineated content. For example, the content may include text, @mentions, hashtags, or a reference to other content, such as a hyperlink. While the text of a media post may provide insight as to what the author that generated the post is feeling, thinking, or experiencing, it will still leave some questions unanswered. For example, the text of one media post may read: “at work”. Unfortunately, “work” could refer to any number of things or places. Accordingly, one or more components of the service 101 are configured to analyze meta information associated with the content dimension of one or more media posts to determine a content profile associated with content in the content dimension (shown as block 722). In particular, this can include identifying a topic profile descriptive of a particular topic of content. In various embodiments this includes tracking keywords, phases, syntax, context, or hashtags. For example, in some embodiments, one or more component of the service 101 is configured to execute NLP on the content dimension of one or more media posts. As used herein, NLP can include machine learning that examines and uses patterns to determine and improve an understanding of the relationships and patterns in content.

Similar to an author profile, topic profiles provide a repository of enrichment data, such as topic information, related to the associated topic. While content profiles are described herein primarily in the context of topic profiles, in various embodiments, other content profiles are envisioned. Responsive to identifying the topic, a corresponding topic profile can be identified, and topic information not include in the media posts may be aggregated and applied to enhance the media post. Continuing with the example provided above, enrichment data may include an identification of “work” as the author's place of employment. Accordingly, the aggregated enrichment data supplements the media post to provide a clarified understanding of the story the media post narrates. Furthermore, media posts having a shared topic may be grouped to permit a user to interact with all the content of a particular topic. This may be particularly useful for detecting breaking news stories, or tracking social media posts associated with particular events.

In various embodiments, a topic profile may not exist for a topic associated with a media post. Accordingly, various embodiments of the present invention include creating a topic profile (additionally shown in block 722). Topic profiles are generated by aggregating information, data, and meta data, and information descriptive of a topic. For example, information descriptive of a topic may be ascertained from additional media posts within the aggregated geographically delineated content. In this regard, the service may be configured to analyze all content associated with a plurality of media posts to formulate groupings, observations, and additional information not provided by an individual media post. The descriptive information is arranged and stored as the topic profile. For example, in various embodiments, responsive to identifying a topic, the service 101 is configured to analyze the remaining media posts within the plurality of media posts of the aggregated geographically delineated content. In various embodiments, one or more components of the service 101 described herein are configured to update the topic profile with each media post received (shown as block 724). For example, an update may occur when a media post provides new content associated with a topic. In various embodiments, updates may be performed automatically to ensure accurate and truthful content information aggregated from the content profiles. Accordingly, the content profile provides a centralized repository of content information.

Furthermore, in some implementations, a media post of the plurality of media posts may not have a content dimension associated therewith. Accordingly, one or more component of the service 101 may be configured to analyze the one or more dimensions associated with the media post not having a content dimension to determine the content profile associated with the media post. For example, in various embodiments the enrichment component is configured to analyze a photograph within an image dimension to determine a topic of the photograph. Accordingly, the topic of the photograph may be used to identify a topic profile and associate corresponding content information with the media post. As such, in various embodiments one or more components are configured to analyze information, data, metadata, or meta information associated with the one or more dimensions of the plurality of media posts of the aggregated geographically delineated content to identify a content profile and aggregate enrichment data, such as content profile information.

With continuing reference to FIG. 7A, in one embodiment, enrichment data can include location information including a venue. In additional embodiments, location information may include time, weather, or other ambient information, among other information. As used herein, venues can include the scene or location of an activity or event. As discussed above, in various embodiments the one or more dimensions can include a location dimension. The location dimension may include any reference associated with a location attached to the media post. For example, in one embodiment the reference may include a check-in.

In various embodiments, location information can include a genuine location or a precise location. As used herein, genuine location refers to a referential geographic position, such as a venue or store location, and precise location refers to navigational positioning, such as GPS location or longitudinal and latitudinal coordinates. Accordingly, one or more components of the service 101 can be configured to analyze one or more location references associated with the location dimension of one of the plurality of media posts to determine a location profile and aggregate location information, such as a venue (shown as block 726). Often media posts will not include a geographic location. This poses a problem, because conventional service will not be able to detect these media posts. Accordingly, enrichment data provides one method of finding media posts not having location information associated therewith.

Similar to the author profiles discussed above, location profiles include a description of the characteristics of the location associated with the respective media post. In particular, location profiles may include a venue profile. Responsive to identifying a location reference, a corresponding location profile can be identified, and location information not included in the media post may be aggregated and applied to enhance the media post. For example, a media post within the plurality may include a check-in. Often, media posts within the aggregated geographically delineated content will include precise location (e.g., longitude and latitude coordinates), but not include genuine location. While informative, the check-in information, or coordinates, is limited and does not provide additional details about the associated location. Accordingly, aggregating enrichment data can include aggregating location information, such as addresses, geographic coordinates, building names, store names, offerings, and reviews, or any other location information stored at a location profile. In various embodiments, location enrichment data may also be tied to the specific time, day, month, year, season and factual elements such as weather or temperature. As such, enrichments associated with location profile information provide the end recipient of the enriched geographically delineated content with a more robust aggregation of content and depiction of the associated location.

In various embodiments, a location profile may not exist for a location associated with a media post. Accordingly, various embodiments of the present invention include creating a location profile (additionally shown in block 726). Location profiles are generated by aggregating information, data, meta data, and meta information descriptive of a location. For example, information descriptive of the location may be ascertained from additional media posts within the aggregated geographically delineated content or one or more social media content providers. The descriptive information is arranged and stored as the location profile. For example, in various embodiments, responsive to identifying a location reference, the service is configured to analyze the remaining media posts within the plurality of media posts of the aggregated geographically delineated content. It is appreciated that each individual media post of a plurality will often provide a different piece of information descriptive of a location. Notably, one or more components of the service described herein may be configured to update the location profile with each media post received (shown as block 728). For example an update may occur when a media post provides new location information associated with a location. In various embodiments, updates may be performed automatically to ensure accurate and truthful content information is aggregated from the location profiles. Accordingly, the location profile provides a centralized repository of location information.

Furthermore, in some implementations, a media post of the plurality of media posts may not have a location dimension associated therewith. Accordingly, one or more component of the service may be configured to analyze the dimensions associated with the media post not having a location dimension to determine the location profile associated with the media post. For example, in various embodiments the enrichment component is configured to analyze a photograph within an image dimension to determine a location of the photograph. Accordingly, the location determined from the photograph may be used to identify a location profile and associate corresponding location information with the media post. In other embodiments, one or more components are configured to analyze time stamps and reference locations of historic media posts of the author that generated the respective media post. Based on an analysis of historic media posts, the service can determine a location associated with a current post. For example, if a first post not having a location associated therewith is time-stamped five minutes after a post having a location of Boston, Mass. associated therewith, the service can be configured to determine with a high degree of certainty that the first post has a Boston, Mass. location. In another example, it can be determined that in the past, ninety-nine percent of media posts having a photograph of a pastry and the word “Boston” are associated with the North End neighborhood in Boston, Mass. Based on the historic certainty, a new post having a photograph of a pastry and the text “Boston”, may be associated with the North End neighborhood. As such, in various embodiments one or more components are configured to analyze information, data, metadata, or meta information associated with the one or more dimensions of the plurality of media posts of the aggregated geographically delineated content to identify a location profile and aggregate enrichment data, such as location information.

In other embodiments, enrichment data can include event information. Event information may include any information relating to an occurrence in a certain place at a particular time. For example, events may include but should not be limited to concerts, festival, parades, fairs, protests, celebrations, parties, carnivals, sporting events, political events, and sales events. In various embodiments, one or more component of the service 101, such as the enrichment component 134, is configured to analyze information associated with one or more of the dimensions of a media post to identify an associated event profile (shown as block 730). Similar to the author profile, content profile, and location profile discussed above, event profiles provide a repository of enrichment data, such as event information, related to the associated event. Responsive to identifying the associated event profile, the component is configured to aggregate enrichment data including event information relating to the identified event not provided in the media post. In various embodiments this includes receiving event information from the event profile. Similar to the author profile described above, event profiles include a description of the characteristics of the event. Characteristics of the event can be ascertained from any associated source, or, in various embodiments, from the plurality of media posts of the aggregated geographically delineated content. For example, characteristics can include time, location, description, proceedings, cause, cost, or offerings. In contrast to venue information, event information has a time frame. Accordingly, various embodiments of the service 101 are not only configured to associate a geographic location with a media post, they are able to associate an event and time frame with the location. As such, enrichment data associated with the event information can provide the end recipient of the enriched aggregated geographically delineated content with a more robust aggregation of content.

In various embodiments, one or more component of the service is configured to generate event profiles (shown additionally in block 730). As described above, event profiles include a description of the characteristics of an event. In one embodiment characteristics of an event are determined by analyzing and cross-referencing one or more dimensions of a plurality of media posts. For example, a first media post may include a photograph of a concert, a second media post may include a description of the concert, and a third post may include a price associated with the concert. The one or more components are configured to determine that each of the first, second, and third post are related to a shared event, create an event profile, and store the associated photograph, description, and price in the profile. Accordingly, the stored information can then be used to enhance each of the first, second, third, or additional media posts. In various embodiments, one or more components of the service described herein are configured to update the event profile with each media post received (shown as block 732).

Turning briefly to FIG. 7B, several embodiments perform processes that enhance stored aggregated geographically delineated content. Accordingly, aggregated geographically delineated content received at a first time, may be deconstructed and enhanced with enrichment data responsive to receiving additional aggregated geographically delineated content at a later, second time. One example of such as process is shown in FIG. 7B. Deconstruction of individual ones of a plurality of media posts from a content provider 748, may be performed as described herein with reference to FIG. 7A. For example the service 750 may deconstruct individual media posts into a plurality of dimensions 752. Each dimension may be used or analyzed to identify an associated profile (block 754) and enhance the individual media post to generate enriched aggregated geographically delineated content (block 756). However, often the service 101 may be unable to identify a profile, or even deconstruct a media post into a particular dimension. For example, one media post may have no location associated therewith, and accordingly not have a location dimension or location profile. Nevertheless, the delineated component 112 can be configured to store the unenhanced aggregated content in a database, such as the database 758. In various embodiments, one or more components of the service 101 are configured to automatically exhaust a predetermined series of algorithms or rules in an attempt to enhance the media post before storing the unenhanced media post.

Responsive to receiving an additional aggregation of geographically delineated content, one or more components of the service 750 are configured to query the database 758 for the unenhanced aggregated geographically delineated content and reattempt to enhance the unenhanced aggregated geographically delineated content. For example, this may include analyzing the dimensions associated with media posts not having a particular dimension, and analyzing the dimensions associated with media posts in the additional aggregated geographically delineated content. Based on the analysis, similarities can be determined. For example, in various embodiments the enrichment component is configured to determine similarity in username within an author dimension to determine enrichment data absent from the unenhanced media post, such as author interests. As such, aggregated geographically delineated content may be used to retroactively enhance stored aggregated geographically delineated content. In various embodiments, retroactively enhancing stored aggregated geographically delineated content includes continually updating the stored content. Machine learning executed by the service 750 can continually enhance stored content with every aggregation of content created. Such an embodiment provides for a more robust and detailed repository of enriched aggregated geographically delineated content. For example, stored content becomes more detailed and specific with each aggregation of content. While described herein as performed by service 750, in various embodiments the service of FIG. 1 is configured to perform, the processes as described with reference to FIG. 7B.

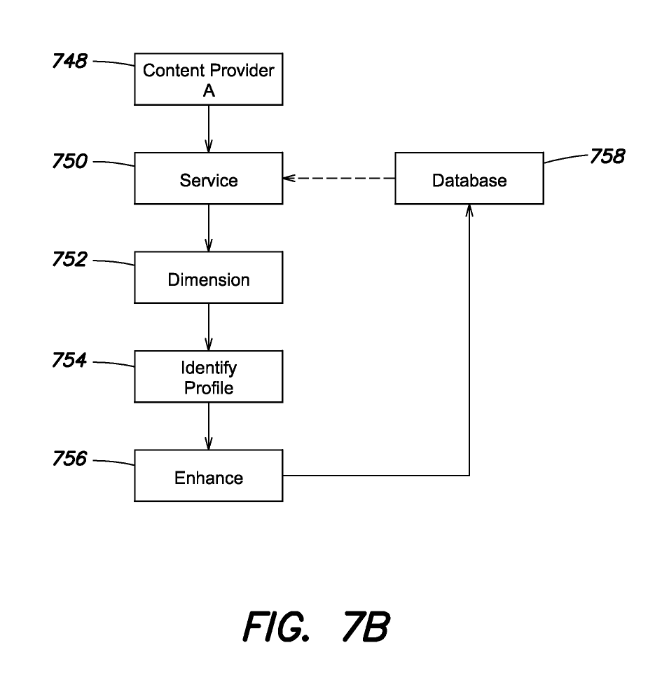

As described above with reference to FIGS. 7A-B, several embodiments perform processes that aggregate enrichment data. In various embodiments, this can include identifying a profile associated with a dimension of an individual media post of a plurality of media posts within the aggregated geographically delineated content. One example of a process of aggregating enrichment data is illustrated in FIG. 8. Process 8 may be executed by one or more components in the service 101, such as the enrichment component 134 discussed herein.

In various embodiments, profiles include a queryable profile identifier and are indexed in a profile database 140 respective to the profile identifier. For example, an author profile can include an author profile identifier used to index the author profile in an author profile database. In one embodiment, author profiles are indexed based on the name of the author. Similarly, location profiles, content profiles, location profiles, and event profiles may additionally include queryable identifiers used to index the profile in an associated database. Accordingly, in various embodiments, identifying a profile can include analyzing meta information associated with at least one dimension of one of the plurality of media posts to realize a profile identifier of an associated profile (shown as acts 802 and 804). Responsive to realizing the profile identifier, the one or more components may query the profile database and receive the profile information discussed herein (shown as acts 806 and 808).

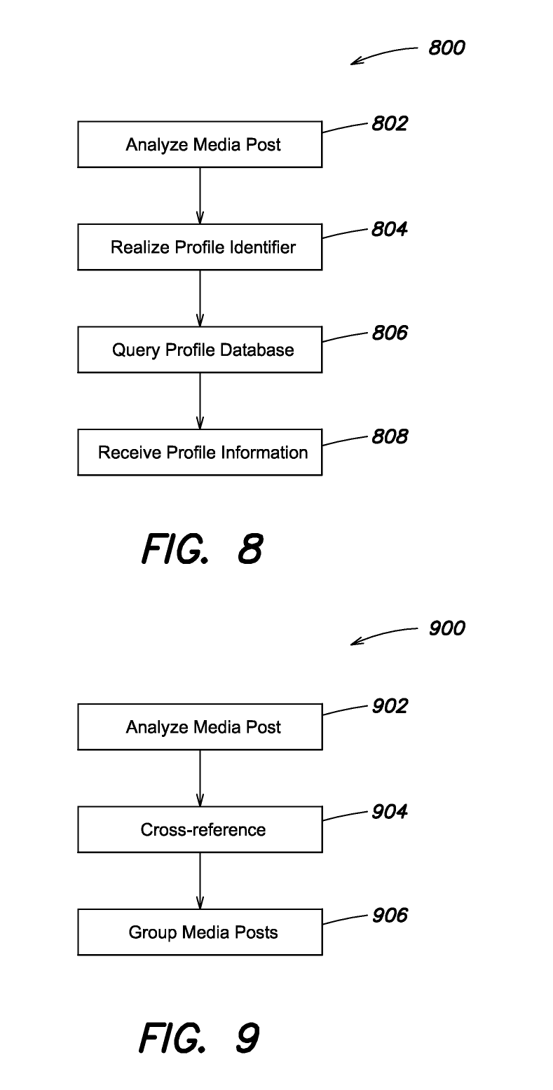

While discussed herein as aggregating enrichment data to enhance the plurality of media posts within the aggregate geographically delineated content, in various embodiments the enrichment component 134 is configured to cross-reference one or more dimensions of one or more media posts to enhance the plurality of media posts. It is appreciated that cross-referenced individual media posts within a plurality of media posts of aggregated geographically delineated content provides a fuller and more robust narrative of the story told by the media posts. One example of such a process is shown in FIG. 9.

At block 902, one or more components of the service 101, such as the enrichment component 134, are configured to analyze one or more dimensions of individual posts of a plurality of media posts. As described above, this can include analyzing meta information associated with any one of an author, location, image, content, or event dimension. Analyzing can include keyword identification, computer vision, author identification, or executing a predetermined set of rules or algorithms to detect a profile identifier.

At block 904, one or more components are configured to cross-reference one or more media posts within the plurality of media posts of the aggregated geographically delineated content. In various embodiments, this includes comparing realized profile identifiers, associated enrichment data, or any other information associated with the media posts. Responsive to cross-referencing individual media posts, posts having a strong correlation or similar information, data, or meta data may be grouped together (shown as block 906). Grouping may be performed automatically by the service 101 at the response of a user or client request. For example, grouping may be performed in response to receiving one or more query parameters for aggregating geographically delineated content.

In various embodiments, groupings are determined based on a comparison score or a shared profile identifier. As used herein, a comparison score quantifies the similarities between one or more media posts. In a first example, a first media post and a second media post from the same author may be grouped based on a shared author profile. Similarly, a first media post and a second media post each having content information related to a “skiing” topic, may be grouped together based on a shared topic profile. In further embodiments, one or more components of the service 101 are configured to group posts based on similar hashtags, mentions, venue, or image scenes. In various embodiments, groupings can be associated with an associated profile and indexed accordingly. In further embodiments, indexed groupings can be queryable or filterable by the end recipient of the enriched aggregated geographically delineated content. It is appreciated that grouping media posts permits the service to relate media posts created at different time periods, at different locations, and by different authors, that otherwise would not have been connected. Accordingly, one or more embodiments discussed herein provide a more detailed and efficient aggregation of geographically delineated content.

Returning to FIG. 1, in various embodiments the service 101 can be configured to store enriched aggregated geographically delineated content in one or more databases, such as the enrichment database 138. This can include storing profiles associated with the one or more dimensions, storing groupings, or storing the enriched geographically delineated content in its entirety. While shown in FIG. 1 as including a content database 122, an enrichment database 138, and a profile database 140, in various embodiments, the service 101 is configured to store aggregated geographically delineated content, enriched aggregated geographically delineated content, and profiles, partitioned within one shared database (e.g., database 121). As such, in various embodiments, the service 101 is configured to store aggregated geographically delineated content and enriched geographically delineated content. For example, responsive to a user input identifying the location Boston, Mass., the service 101 may aggregate geographically delineated content and provide groupings for recent posts, photograph topics, hashtags, @mentions, venues, and/or authors. For example, photograph topics may include a list such as person, food, snow, dog, winter, sport, coffee, river, etc. Groupings as described in this example permit the user to filter, sort, or otherwise efficiently navigate through the aggregated content.

In various embodiments, enriched aggregated geographically delineated content may be stored in a geographic quadrant based storage grid. In other embodiments, the enriched aggregated geographic content may be stored in a time-based grid, in which the enriched aggregated content is stored based on the time the geographic content was generated by the content provider. In other embodiments, enriched aggregated content can be stored in an aggregation-time-based grid, in which enriched aggregated content is stored based on the time the geographic content was aggregated by the delineation component. In further embodiments, the enriched aggregated content can be stored in a subject-based grid, in which enriched aggregated content is stored based on the source or the type of the geographically delineated content (e.g., Twitter, Facebook, MySpace, LinkedIn, Pinterest, or Tumblr content). It should be appreciated that enriched geographically delineated content can be stored in any other fashion as is suitable for geographically delineated content. However, it should be appreciated that such aggregations permit such content to be more easily located (e.g., through a query or display on a heat map). Further, because such aggregations may be performed automatically (e.g., by a service), more advanced analyses can be performed on the data prior to receiving specific user queries, and notifications may be performed without the need for user intervention (e.g., a detection of increased social media activity responsive to a sports event).

### Example Trending Systems and Methods

Returning to FIG. 1, wherein a block diagram of a location-based service and system suitable for incorporation of various aspects of the present invention is shown, in various embodiments the service may detect an incongruity from a comparison of one or more enriched sets of aggregated geographically delineated content. For instance, the service may permit one or more users (e.g., user 102) to receive a detected trend in enriched aggregated geographically delineated content associated with the user's input identifying a geographic location. For example, the detected trend may include a percentage increase in author's posting in the North end neighborhood of Boston, Mass. Trends permit a user to analyze or discover the source of social media tendencies. Trends may also include percentage increases in a volume of media posts associated with a particular topic, or top hashtags, top @mentions, or locations, such as venues. Users may use the interface of the user device 104 for interacting with the system 100 to receive detected incongruities, such as trends, in enriched aggregated geographically delineated content. In another embodiment, detection of the incongruity may include an identification of singular or groups of content that are out of the ordinary for a particular place and/or time. In another example, detection of the incongruity may be a distinctiveness measure of particular media posts of a first set of aggregated content with respect to media posts of a second set of aggregated content (which may also be determined based on place and/or time). It should be appreciated that any number of methods may be used to detect any type of incongruity of interest. In other embodiments, the service may permit the one or more third party client systems (e.g., client 130 shown in FIG. 1) to receive detected incongruities in enriched aggregated geographically delineated content associated with the client's input identifying a geographic location.

Service 101 may also provide one or more related services, such as a service for detecting an incongruity from a comparison of one or more enriched sets of aggregated geographically delineated content. Such services may be integral to service 101 or may alternatively operate in conjunction with service 101 (e.g., by communicating with the service 101 through an Application Programming Interface (API)). In some implementations, the service 101 is configured to execute one or all of a plurality of components including the delineation component 112, the relation component 114, the communication component 116, the deconstruction component 132, and the enrichment component 134. Additionally, the service can be configured to execute a trend component 136. One or more of the components shown in FIG. 1 are configured to detect an incongruity from a comparison of one or more enriched sets of aggregated geographically delineated content. In one embodiment, detecting an incongruity includes comparing an enriched first set of aggregated geographically delineated content aggregated for a first time frame to an enriched second set of aggregated geographically delineated content aggregated for a second time frame. In various embodiments, incongruities include any inconsistency between at least a first set of content and a second set of content, and, in various embodiments, may include trends. It is appreciated that incongruities are detected relative to the geographic location defined by the user or client in the input.

As described above, several embodiments perform processes that detect an incongruity from a comparison of one or more enriched sets of aggregated geographically delineated content. In some embodiments, these processes are executed by a service, such as service 101 described above with reference to FIG. 1. One example of such a process is illustrated in FIG. 10.

At block 1002, an input identifying one or more geographic locations is received from an user or a client, over a network 118. At block 1002, a website or application (e.g., application executing on the user device 104) may be displayed to the user 102. Alternatively, an interface such as an API (e.g., API 126) may be provided to an application for providing the input to another application or system, such as the client 130. As discussed above, the input may be provided via one or more interfaces and received at the interface 108 of the service 101. Also, the input may be received from a third party application or system that utilizes location-based services. In various embodiments, the input further defines first time for which to aggregate the first set of aggregated geographically delineated content. For example, this may include a range of days, weeks, months, or years. Users or clients may specify the specific day, month, or year that is desired. For purpose of example only, a user input may include a date range of Jan. 1, 2015 to Jan. 10, 2015 (the current date). Furthermore, in various embodiments the time frame may further include the time of day desired. For example, the time frame may include the parameters 9:00 AM PST to 12:00 PM PST. Various other parameters used to define a time frame may be used with further embodiments.

In act 1004, a component within the service 101 is configured to communicate with at least one content provider (e.g., content provider 120 shown in FIG. 1) through a network connection, e.g., network 128, and/or communicate with a geographically delineated content database, e.g., database 121 to perform a query. As discussed above, the input received by the interface 108 further can include one or more query parameters specifying the geographically delineated content requested. Accordingly, the user or client can specify the type or topic of geographic delineated content that is aggregated and distributed.

In response to receiving the input, the delineation component 112 generates a query compatible with the one or more content providers 120, including at least the geographic location defined by the user or client. For example, the query can be formatted to request geographic delineated content from one or more content provider APIs 124. The APIs 124 associated with one or more content providers 120 permit the exchange of geographic delineated content. In various embodiments, the query may additionally include the time frame or other time based parameters specified in the input. Such querying processes are described above with reference to block 206 of FIG. 2.

As further discussed above, one or more components of the service 101 are configured to aggregate geographically delineated content in response to a user or client input (shown as act 1006). Such a process is described in detail above with reference to block 208 of FIG. 2. In various other embodiments, the delineation component is configured to query one or more content providers 120 and aggregate geographically delineated content automatically. In further embodiments, the delineation component 112 is configured to continually query content providers 120 for content relative to frequently requested geographic locations. Automatic queries may be time scheduled or random. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.). Frequency and/or range may be determined based on other criteria, such as time of day, history of activity in particular geographic locations, a prior knowledge of events taking place at particular locations (e.g., an sports event, an election, etc.), or other criteria. It should be appreciated that other methods for processing content may be possible. For example, aggregation of content need not be performed responsive to a query (e.g., a feed may be received for a particular location on a regular or scheduled basis).

In various embodiments, one or more components of the service 101 are configured to filter the aggregated geographically delineated content. Filtering can be performed automatically based on predetermined filtering parameters, or performed responsive to one or more user or client commands. In one embodiment, aggregated geographically delineated content is filtered to normalize individual media posts within the aggregated content prior to detecting an incongruity. Media posts may be tempered based on any of the dimensions or enrichment information discussed herein. In various embodiments, one or more components of the service 101, such as the delineation component 112, are configured to accommodate for media posts from a particular location having a historically strong correlation with a particular topic, or type of enrichment information. For example, there may always be an abundance of media posts associated with the North End neighborhood of Boston, Mass. and the topic “food”. This may be regardless of the time of year, weather conditions, social events, traffic conditions, etc. Accordingly, in various embodiments, one or more components of the service are configured to filter the media posts associated with the North End neighborhood to temper media posts with the historically popular topic (e.g., “food”). Tempering such media posts further exposes or reveals changes in enrichment information for incongruity detection.

In block 1008, a component within the service 101 is configured to communicate with at least one content provider (e.g., content provider 120 shown in FIG. 1) through a network connection, e.g., network 128, and/or communicate with a geographically delineated content database, e.g., content database 122 to perform a second query. The second query is performed for the same geographic location as the first query and may include one or more parameters specifying the geographically delineated content requested. In various embodiments, the second query is performed automatically in response to, or simultaneously with, a first query, such as the query discussed above with reference to block 1004. In various embodiments, the second query defines a second time for which to aggregate the second set of aggregated geographically delineated content. For example, this may include a range of days, weeks, months, or years. The second time frame may be determined automatically responsive to a user identified time frame for which to aggregate the first set of geographically delineated content. For example, in one embodiment, the time span of the second time frame is defined to match the time span of the first time frame. Accordingly, if a user selects a first time frame having a span of five days, the second time frame is defined to cover a time span of five days. In alternative embodiments, the second time frame consists of a predetermined default span of time independent of the first time frame.

In various embodiments, the second time frame temporally precedes the first time frame for the defined time span. Accordingly, the second time frame is defined so as to end at the beginning point of the first time frame. In various examples, this point may be a day, month, year, or time of day (e.g., minute or hour). For example, responsive to receiving a first time frame of Jan. 1, 2015 to Jan. 10, 2015, the one or more components of the service 101 can be configured to define a second time frame for which to aggregate geographically delineated content of Dec. 23, 2014 to Jan. 1, 2015.

Responsive to the second query, one or more components of the service 101 are configured to aggregate a second set of geographically delineated content (shown as act 1010). Similar to the process described in detail above with reference to block 208 of FIG. 2, the delineation component 112 receives and aggregates the second set geographically delineated content from the one or more social media content sources. In various embodiments, social media content sources can include a content provider, such as content providers 120, or a content database, such as database 121. In various embodiments the database 121 includes an enrichment database 138. For example, aggregated content can include social media content having a geographic location associated with the geographic location identified in the input. Content may be aggregated from one or a plurality of content providers 120, as discussed above, in one or a plurality of formats. Although shown in FIG. 10 as configured to aggregate a first and a second set of geographically delineated content. In various embodiments, the delineation component 112 can be configured to aggregate, a third, fourth, fifth, or predetermined amount of content sets.

In act 1012, one or more components of the service 101, such as the enrichment component 134 are configured to enhance the one or more sets of aggregated geographically delineated content with enrichment data to generate one or more enriched sets of aggregated geographically delineated content. In one embodiment, this can include an enriched first set of aggregated geographically delineated content and an enriched second set of aggregated geographically delineated content.

As discussed above with reference to acts 606-610 of FIG. 6, in various embodiments, one or more components of the service 101 are configured to automatically deconstruct individual media posts of the plurality of media posts of the aggregated geographically delineated content. Posts are deconstructed into a plurality of dimensions. For example, in one embodiment, deconstruction may be executed by a deconstruction component 132 operating in the service 101. In various embodiments, dimensions may include an author dimension, an image dimension, a location dimension, and/or a content dimension. Dimensions may further be divided by the deconstruction component 132 into a plurality of sub-dimensions. As discussed herein, each dimension or sub-dimension corresponds to information, data, meta data, or meta information associated with the media post.

Responsive to deconstructing the plurality of media posts, one or more components of the service may be configured to automatically aggregate enrichment data related to at least one of the dimensions of each of the individual media posts. In various embodiments, aggregating enrichment data includes analyzing the dimensions of each individual media post. In particular, the enrichment component 134 can be configured to realize an identifier associated with a profile having enrichment data. For example, in various embodiments this may include realizing and querying an author profile, a content profile, a location profile, or an event profile. As discussed herein, enrichment data may include author profile information, venue information, content information, location information, event information, or any other information not provided by the content provider from which the media post is provided.

In various embodiments, enhancing the one or more sets of aggregated geographically delineated content includes enhancing the plurality of media posts within the first and/or second set of aggregated geographically delineated content. As discussed herein, enhancing at least one of the individual media posts includes adding, exposing, identifying, or otherwise providing information, data, meta data, or meta information not accessible in the associated media post. It is appreciated that often a content provider 120 will not provide a full story associated with a media post. For example, in various embodiments, enhancing the plurality of media posts includes providing a visualization of enrichment data to present a more robust narrative of the story told by the media post. Enhancing the plurality of media posts, can include providing additional data related to at least one of an author dimension, a content dimension, a location dimension, or an image dimension. In further embodiments, enhancing the aggregated geographically delineated content with enrichment data permits the service to categorically group related media posts that would not have otherwise been identified as related.

At block 1014, one or more components of the service 101 are configured to detect an incongruity from a comparison of the one or more enriched sets of aggregated geographically delineated content. As discussed above, incongruities can include any inconsistency between at least a first set of content and a second set of content, and, in various embodiments, may include trends. For example, incongruities may include a change in: geographically delineated content volume (e.g., media post volume), volume of authors that generated respective media posts, volume of media posts associated with a venue, volume of impressions, volume of media posts associated with a topic, or volume of image identifications. In other examples, incongruities may include: introduction of an author having an influence level above a predetermined threshold, introduction of a new author, introduction of a new topic, top hashtags, top @mentions, trending venues, or a timeline of content. It is appreciated that incongruities are detected relative to the geographic location defined by the user or client in the input.

At block 1016, one or more components, such as the communication component 116, are configured to distribute the detected incongruity. For example, the communication component 116 may be configured to distribute a trend between the first set of content and the second set of content to the one or user devices (e.g., user device 104 discussed above) or clients (e.g., client 130 discussed above) permitting the respective user or client to display and view the trend.

In various embodiments, one or more components, such as the relation component 114, are configured to generate a visualization of the detected incongruity. As described above, the relation component 114 may determine a heatmap visualization from the comparison of an enriched first set of aggregated geographically delineated content and an enriched second set of aggregated geographically delineated content. As used herein, one embodiment of a heatmap visualization include an image of the geographic location (e.g., a map). For example, the image may include a street map, a satellite image, a mass transit map, or a schematic illustration of a detectable activity. Heatmaps may also include one or more indicators layered over the image of the geographic location (e.g., color films). The indicators are configured to show the density of the volume of the geographically delineated content for a discrete spatial area, a series of spatial areas, or discrete points, on the map and can include but should not be limited to colors, shapes, and images. In one implementation, the heatmap visualization shows a range of colors conveying the volume of social media content in the geographic location to help the user or client understand the geographic layout of social media content or activity.

In one embodiment, the heatmap visualization permits the user, or client, to interact with the geographically delineated content in the associated geographic location. For example, in response to selection of one or more indicators the heatmap is configured to display the geographically delineated content associated with the underlying geographic location. While shown and discussed herein as a heatmap or other geographical depiction, in various other embodiments the generated visualization may include a chart, graph, table, pie chart, diagram, or any other visual aid.

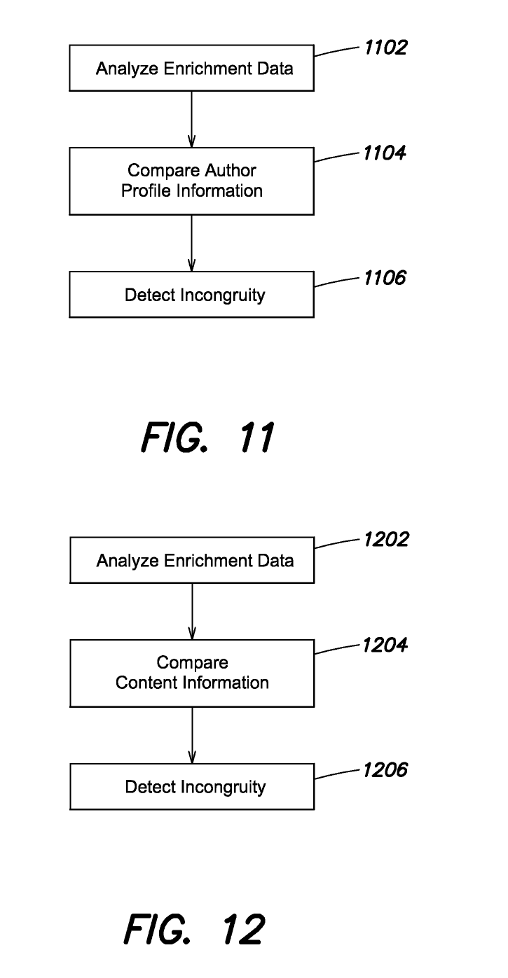

As described above, several embodiments perform processes that detect an incongruity from a comparison of an enriched first set of aggregated geographically delineated content and an enriched second set of aggregated geographically delineated content. In some embodiments, these processes are executed by a service, such as service 101 described above with reference to FIG. 1. In particular, these processes may be executed by a trend component 136 operating in the service 101. Various examples of such processes are illustrated in FIGS. 11-15.

Turning to FIG. 11, one or more components of the service 101, such as the trend component 136, are configured to analyze enrichment data associated with individual media posts within the enriched first set of aggregated geographically delineated content and the enriched second set of aggregated geographically delineated content (shown as block 1102). As discussed herein, enrichment data may include author profile information associated with an author profile of the author that generated the respective media post. In various embodiments, analyzing enrichment data includes identifying an avatar, profile photograph, username, full name, bio, website, location, date joined, verification status, activity, number of followers, favorites, education, sentiments, connections, age, employment status, employer, relationship status, date birth for the author, gender, or any other author identifying characteristics for the author.

At block 1104, one or more components of the service 101, such as the trend component 136, are configured to compare author profile information of the enriched first set of aggregated geographically delineated content and author profile information of the enriched second set of aggregated geographically delineated content. In various embodiments, this includes comparing an avatar, profile photograph, username, full name, bio, website, location, date joined, verification status, activity, number of followers, favorites, education, sentiments, connections, age, employment status, employer, relationship status, date birth for the author, gender, or any other author identifying characteristics for the authors that generated individual media posts. In particular, comparisons may generate a relevancy score quantifying the similarity or dissimilarity between one or more authors. In various embodiments, comparison of the author profile information of individual media posts in the enriched first set of content and the enriched second set of content indicates the volume of authors generating content at a discrete point within an identified geographic location. For example, for a user or client identified geographic location of Boston, Mass., a comparison may indicate that there is an increase in authors in the North End neighborhood. Similarly, it may indicate that there is a decrease in authors in the South End neighborhood. Accordingly, increases or decreases in the volume of authors identified by the author profile information can be detected as an incongruity (block 1106).

In one particular embodiment, author profile information may include an influence level (“influence”). Influence levels associated with each individual author profile indicate the ability of the author to drive other authors or compel activity. For example, influence level may be based on the number of followers, the number of friends, number of re-tweets, amount of comments received, characteristics of friends or followers, or any other activity of the author. As such, influence level enrichments can be used to detect an incongruity. In various embodiments, the trend component 136 is configured to compare influence levels of one or more authors associated with a media post of the enriched first set of aggregated geographically delineated content to a predetermined threshold. If the threshold is exceeded, a “high influence” author is detected and a corresponding incongruity is detected. Furthermore, in various embodiments, influence level may be used to track entry and exit of “high influence” authors in the identified location. In such an embodiment, the trend component 136 is configured to compare the high influence authors of the enriched first set of aggregated geographically delineated content and the high influence authors of the enriched second set of aggregated geographically delineated content. Presence of a high influence author in the first set and absence in the second set indicates that a high influence author has entered the identified geographic location. Presence of a high influence author in the second set and absence in the first set indicates that a high influence author has exited the geographic location. Accordingly, in various embodiments detecting an incongruity can include identifying a high influence author, or tracking the movement of a high influence author.

In a further embodiment, author profile information may include impressions associated with individual media posts of one or more authors. Impressions include a measurement of the amount a media post is viewed. As discussed herein, this can include organic impressions, paid impressions, or viral impressions. In various embodiments, the trend component 136 is configured to compare one or more impressions associated with the enriched first set of aggregated geographically delineated content and one or more impression associated with the enriched second set of aggregated geographically delineated content. In various embodiments, detecting an incongruity can include detecting a change in the volume of impressions between the first set and second set of content. In various embodiments, this includes detecting an increase or decrease in volume between the first frame and second time frame.

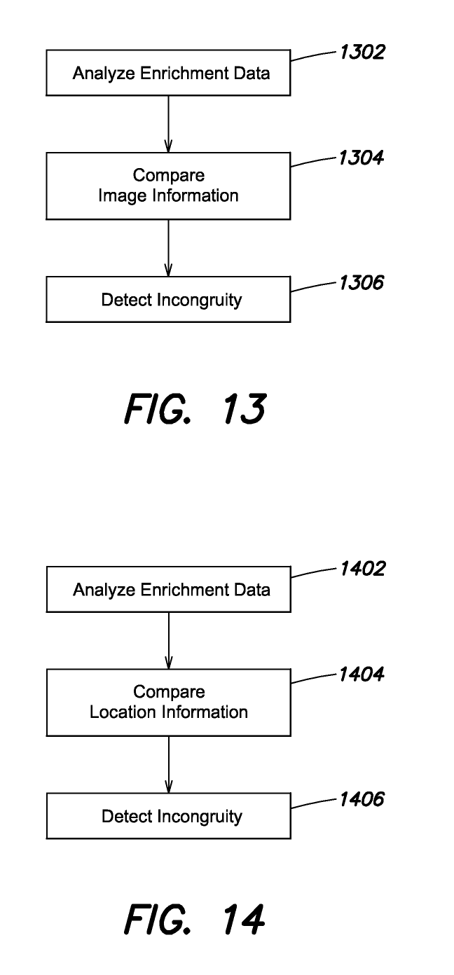

Turning to FIG. 12, one or more components of the service 101, such as the trend component 136, are configured to analyze enrichment data associated with individual media posts within the enriched first set of aggregated geographically delineated content and the enriched second set of aggregated geographically delineated content (shown as block 1202). As discussed herein, enrichment data may include content information. In various embodiments, content information includes topic, text, or a reference to other content, such as a hyperlink. Content information can be associated with a content profile, such as a topic profile. Similar to an author profile, topic profiles provide a repository of enrichment data, such as topic information, related to the associated topic.

At block 1204, one or more components of the service 101, such as the trend component 136, are configured to compare content information of the enriched first set of aggregated geographically delineated content and content information of the enriched second set of aggregated geographically delineated content. In various embodiments, this includes comparing topic, text, @mentions, hashtags, or a reference to other content, such as a hyperlink. In particular, comparisons may generate a relevancy score quantifying the similarity or dissimilarity between content information. In various embodiments, comparison of the content information of individual media posts in the enriched first set of content and the enriched second set of content indicates the volume of content associated with a particular topic. For example, for a user or client identified geographic location of Boston, Mass., a comparison may indicate that there is an increase in the topic of “snow” in the North End neighborhood. Similarly, it may indicate that there is a decrease in topic the topic of “sunshine” in the South End neighborhood. Accordingly, increases or decreases in the volume of topics identified by the content information can be detected as an incongruity (block 1206). Although described herein primarily in the context of topic, the trend component 136 may be further configured to detect changes in the volume of hashtags, @mentions, hyperlinks, or any other content information of the first and second sets of content from the first time frame to the second time frame. In one embodiment, this may include detecting a top hashtag or @mention. Top hashtags and @mentions provide a listing of the most voluminous hashtags and @mentions for the identified location. For example, the top hashtags and top @mentions for a location may appear as #boston, #cambridge, #food, #dog, and @dog, @JillKing, and @JohnAdams. Similarly, the trend component can be configured to detect the introduction of new content information, such as a topic, from the first time frame to the second time frame. Detection of new topics permits a user to quickly identify news stories or time sensitive information.

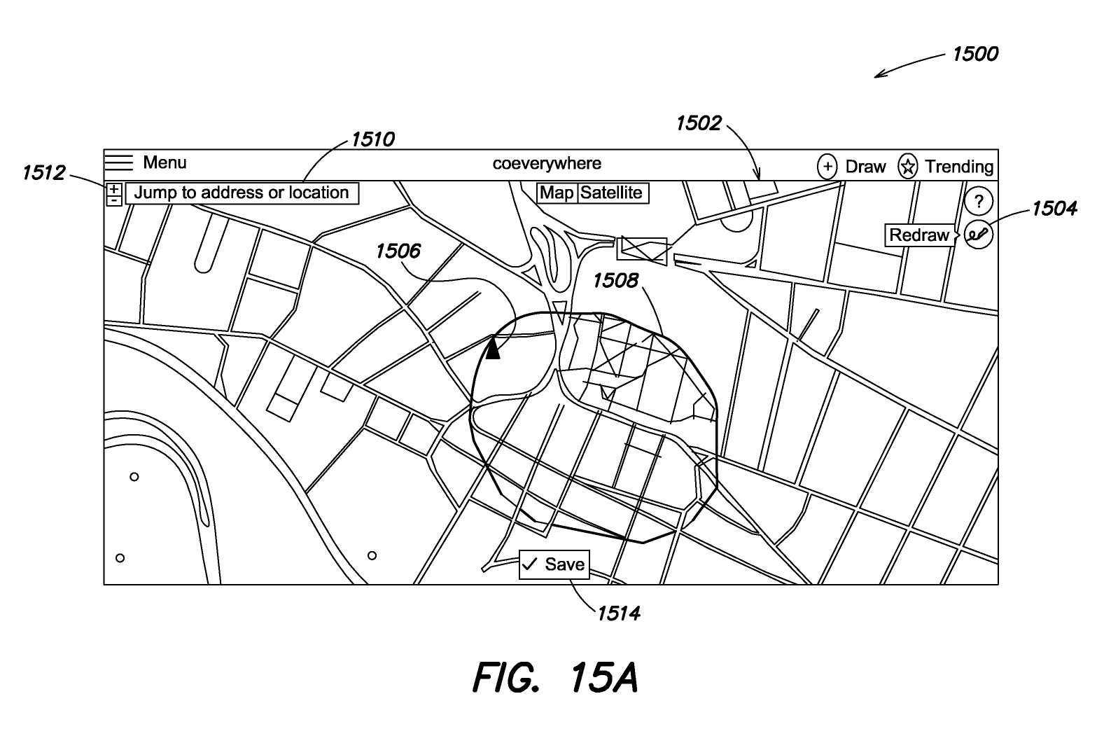

Turning to FIG. 13, one or more components of the service 101, such as the trend component 136, are configured to analyze enrichment data associated with individual media posts within the enriched first set of aggregated geographically delineated content and the enriched second set of aggregated geographically delineated content (shown as block 1302). As discussed herein, enrichment data can include image information such as an identification of a reference including a photograph topic, a photograph scene, a depicted logo, facial features, spam, or memes.

At block 1304, one or more components of the service 101, such as the trend component 136, are configured to compare image information of the enriched first set of aggregated geographically delineated content and image information of the enriched second set of aggregated geographically delineated content. In various embodiments, this includes comparing an identification including a photograph topic, a photograph scene, a depicted logo, or facial features. In particular, comparisons may generate a relevancy score quantifying the similarity or dissimilarity between image information of the enriched first set of content and the enriched second set of content. In various embodiments, comparison of the image information of individual media posts in the enriched first set of content and the enriched second set of content indicates a change in image identifications at a discrete point within an identified geographic location. For example, for a user or client identified geographic location of Boston, Mass., a comparison may indicate that there is an increase in photographs in the North End neighborhood having photograph topic of “snow”. Similarly, it may indicate that there is a decrease in photographs having a photograph topic of “sunshine” in the South End neighborhood. Accordingly, increases or decreases in the volume of image references identified by the image information can be detected as an incongruity (block 1206).

In various embodiments, incongruities may also include a percentage increase or decrease in a particular photographic topic. For example, a time span of three days may show a nine-hundred percent increase in photographs associated with the topic “winter”, a twelve percent increase in photos associated with the topic “tree”, and a one-hundred and twenty percent decrease in photographs associated with the topic “building”. As such, trending image information permits a user to efficiently navigate and access social media content for an identified location.

Although primarily described herein in the context of volume, the trend component 136 may be further configured to detect discrepancies in the range of image information generally associated with media posts corresponding to an identified geographic location. For example, the majority of media posts associated with the North End neighborhood and having a photograph may have a photograph topic of “food”. Accordingly, in various embodiments, an incongruity includes a media post having a photograph topic not corresponding to “food”. As such, in various embodiments, the trending component 136 can be configured to perform a series of rule or algorithms to detect discrepancies in historically consistent image information.

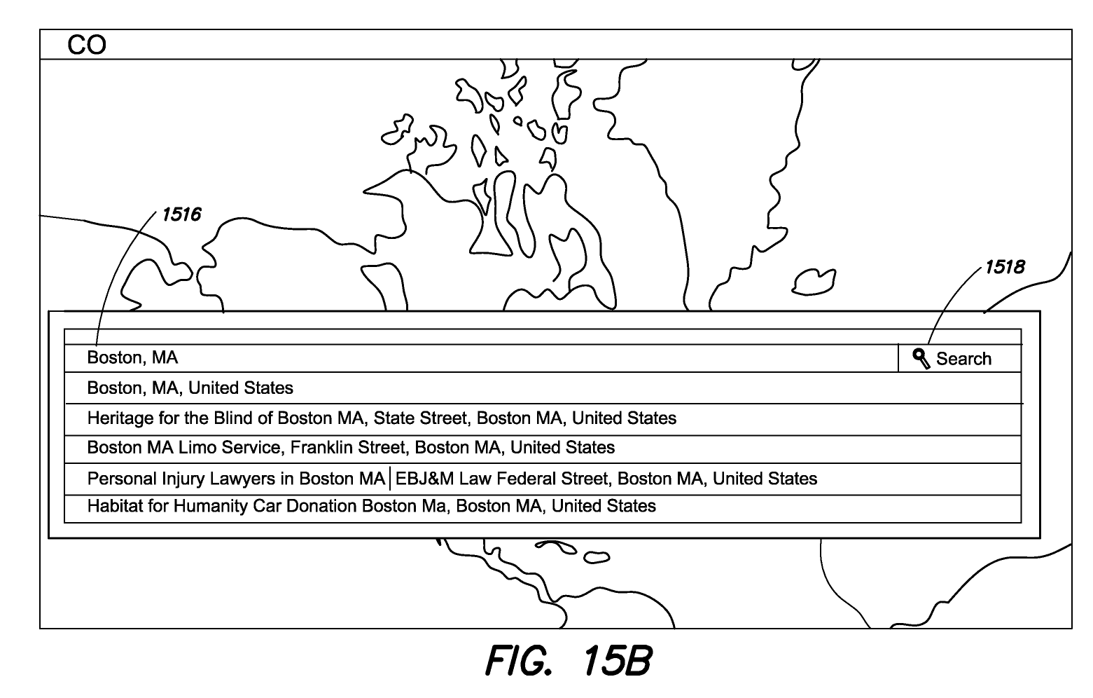

Turning now to FIG. 14, one or more components of the service 101, such as the trend component 136, are configured to analyze enrichment data associated with individual media posts within the enriched first set of aggregated geographically delineated content and the enriched second set of aggregated geographically delineated content (block 1402). As discussed herein, enrichment data may include location information, such as venue information. As used herein, venues can include the scene or location of an activity or event. In additional embodiments, location information can include addresses, geographic coordinates, building names, store names, offerings, reviews, or any other location information stored at a location profile.

At block 1404, one or more components of the service 101, such as the trend component 136, are configured to compare location information of the enriched first set of aggregated geographically delineated content and the location information of the enriched second set of aggregated geographically delineated content. In various embodiments this includes comparing venue information, addresses, geographic coordinates, building names, store names, offerings, reviews, or any other location information stored at a location profile. As discussed herein, comparison of the location information may generate a relevancy score quantifying the similarity or dissimilarity between the location information of individual posts in the enriched first set and enriched second set of geographically delineated content.

In various embodiments, comparison of the location information of individual media posts in the enriched first and second set of content indicates a change in the volume of posts associated with a particular location from the first time frame to the second time frame. Accordingly, increases or decreases in volume of media posts associated with location information may be detected as an incongruity (block 1406). The location may be a discrete point, such as GPS coordinates, or a longitude and latitude, an address, a neighborhood, a town, a city, a county, a state, a country, a business of operation, a store location, or any other geographic location. For example, comparison of location information may indicate that there is a sharp increase of media posts associated with the North End neighborhood of Boston, Mass. In an additional example, comparison of venue information may indicate that there is a sharp increase of media posts associated with the Boston Convention Center. In various embodiments, increases or decreases in media posts associated with a venue can be used to generate one or more trending venues. Trending venues may include venues having an increased volume of social media posts associated therewith. This may include any of the enrichment data discussed herein. For example, during a concert at the Boston Convention Center there may be a sharp increase in media posts including hashtags, @mentions, or check-ins associated with the Boston Convention Center. Accordingly, the trending component may be configured to detect this increase in each type of information and add the Boston Convention Center to a list of trending locations. Trending locations accordingly permit a user to identify “hotspots” of social media activity with an identified geographic location.

It is appreciated that comparing the first and second set of enriched geographically delineated content based on enrichment data, permits the service to compare analytics that would not otherwise be associated with the media posts. For example, although a media post aggregated from the content provider Twitter may not arrive with an associated location, the enrichment component 134 permits the trend component 136 to compare the Twitter media post with location information of other media posts.

As discussed herein, one or more components of the service 101 can be configured to cross-reference media posts and group posts having related information, data, or meta data. For example, grouping can be based on a profile identifier associated with an author profile, content profile, location profile, event profile, or venue profile. Often this shared information may be most useful to a user or client. Accordingly, in various embodiments the one or more components of the service 101, such as the trend component 136, can be configured to detect an incongruity from a comparison of one group of enriched geographically delineated content to an additional group of enriched geographically delineated content. As discussed above, in various embodiments, incongruities may include trends. A trend represents a tendency or a direction of the media posts within the aggregated geographically delineated content. In various embodiments, one or more visualization of a trend can include a geographic representation, a chart, graph, table, pie chart, diagram, percentage or any other visual aid.

In various embodiments, one or more components of the service 101 are further configured to receive an alert condition that defines an alert parameter. In one embodiment, the user or client can specify the alert condition in an input. Alert parameters can consist of any enrichment data associated with one or more media posts. For example, alert parameters may include author profile information, content information, location information, venue information, location information, or raw data information. Such parameters can specify when the alert condition is satisfied. For example, this can include generating an alert when an incongruity is detected. For example, one alert condition may define an alert parameter corresponding to high influence authors in the North End neighborhood of Boston, Mass. In particular, the alert parameter may specify high influence author's with a following of more than 1 million followers. When an incongruity is detected by the trend component 136, and that incongruity includes the identification of an author corresponding to the alert parameter, the alert condition is satisfied, and an alert is generated. In various embodiments, generated alerts may be distributed to one or more users or clients. For example, alerts may be distributed through text messaging, e-mail, phone call, or any other delivery service. In further embodiments, one or more components may distribute alerts through a content provider's corresponding API (e.g., content provider 120 and API 124 shown in FIG. 1). Although described herein as applied to high influence authors, alerts may be generated based on any enrichment data such as content topics, venue, or photograph topics, to name a few.

### Example Interfaces

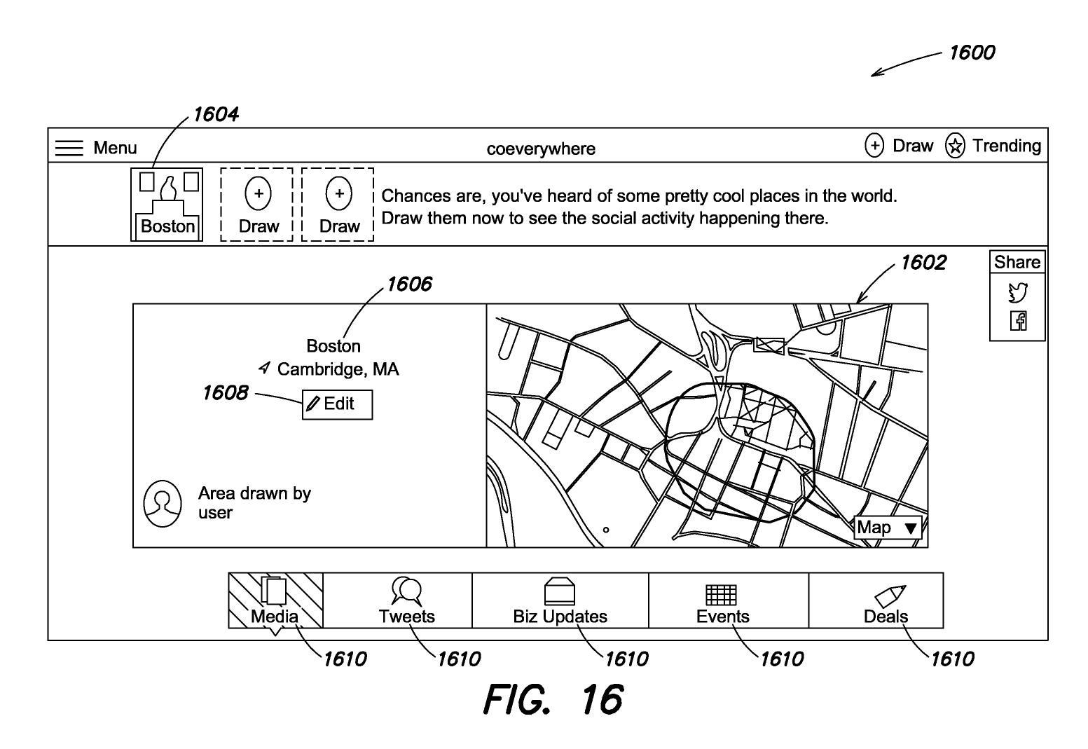

FIG. 15A shows one example interface in which a user or client may enter an input defining a geographic location according to one embodiment. In various embodiments, user interfaces, as discussed herein, may include one or more interface components configured to receive the entered input. In particular, the interface 1500 includes a visual representation of a geographic image (e.g., map 1502). In one embodiment, the interface includes a map query 1510 permitting the user, or client, to call a desired map or map dimensions. For example, the map query 1510 can enable the user to call a map for Boston, Mass., Suffolk County, or the State of Massachusetts. Furthermore, the embodiment can further include a view indicator 1512 permitting the user, or client, to zoom-in or zoom-out on the map 1502. The interface 1500 may also include a drawing tool indicator 1504 that provides a drawing tool (e.g., tool 1506) permitting the user, or client, to interact with the map 1502 to define the bounds of the identified geographic area. In one embodiment, dragging, pulling, or otherwise moving the tool across the map 1502 forms a polygon 1508 indicating a geographic location. In a further embodiment, the tool 1506 additionally permits the user, or client, to reshape, adjust, move, or otherwise redefine the polygon 1508. Although not shown, the polygon 1506 may also include a series of points permitting the user to drag, push, or pull edges of the polygon shape.

According to one embodiment, the interface 1500 may include a search query area where users may enter text based search queries, for example the query parameters discussed above with reference to FIGS. 1-3. FIG. 15B shows an additional exemplary embodiment of an interface having a search query area 1516. Furthermore, the interface may include a control, which when activated, queries at least one geographically delineated content provider for geographically delineated content within the indicated geographic location (e.g., polygon 1508). For example, the control may include a search indicator 1518. Such a search query may be responsive to one or more controls or one or more query inputs to limit the number of media posts within the aggregated geographically delineated content.

Turning back to FIG. 15A, in one embodiment, the interface 1500 may further include save indicator 1514 permitting the user, or client, to store the entered input or polygon at a data store. In various embodiments, the user or client can label or otherwise “name” a polygon or geographic location specified in the input. Stored inputs can be associated with user profiles and recalled from the data store.

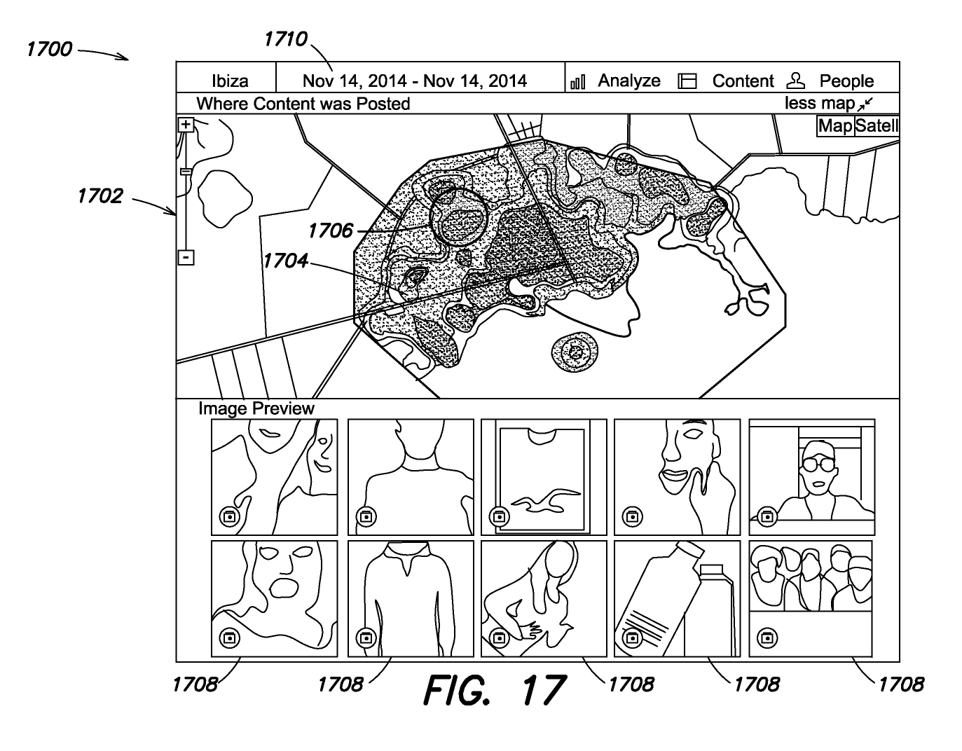

FIG. 16 shows an example interface (e.g., interface 1600) for displaying aggregated geographically delineated content according to one embodiment of the present invention. In particular, the interface 1600 includes a visual representation of an indicated geographic location (e.g., map 1602). As shown, the map 1602 can include a map and a polygon, such as map 1502 and polygon 1508 discussed above with reference to FIG. 15A. In one embodiment, the interface 1600 includes a title identifier 1606 associated with the map 1602. The title identifier 1606 can include a name, a place, or any other descriptor generated by the user or client. The interface 1600 can additionally include an edit indicator 1608 permitting the user or client to edit the title identifier 1606. In one embodiment, the interface 1600 permits the user or client to alternate between one or more maps. For example, the interface 1600 can include one or more visual map indicators 1604. Selection of a map indicator expands the selected map for user or client interaction.

In one embodiment, interface 1600 may also include one or more content tabs 1610 for displaying geographically delineated content in response to the user or client input. As shown in FIG. 16, content tabs can include but should not be limited to media, tweets, business updates, events, and deals. Selection of a content tab 1610 displays the aggregated geographically delineated content associated with the indicated geographic location (e.g., polygon). For example, selection of a content tab 1610 for “tweets” displays Twitter posts having an associated geographic location falling within the defined polygon. Content tabs 1610 permit the user, or client, to filter and/or compartmentalize aggregated geographically delineated content.

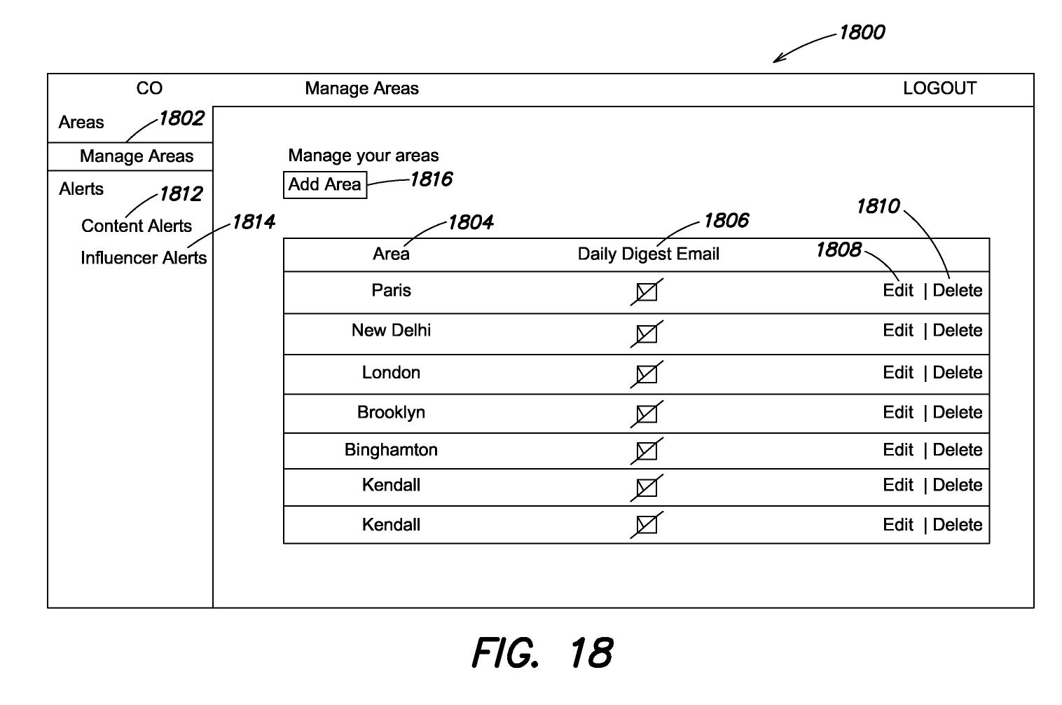

FIG. 17 shows an example interface (e.g., interface 1700) for displaying and permitting a user or client to interact with a heatmap visualization, according to one embodiment of the present invention. In particular, the interface 1700 includes a heatmap visualization 1702 generated in response to aggregated geographically delineated content for an indicated geographic location. As shown, the heatmap 1702 can include a map and a polygon, such as map 1502 and polygon 1508 discussed above with reference to FIG. 15A. The map may additionally include a view indicator permitting the user, or client, to zoom-in or zoom-out on the map, such as view indicator 1512, shown in FIG. 15A.

Heatmap 1702 also includes one or more indicators 1704 layered over the image of the geographic location (e.g., color films). The indicators 1704 are configured to show the density of the volume of the geographically delineated content for a discrete spatial area, a series of spatial areas, or discrete points, on the map and can include but should not be limited to colors, shapes, and images. In one implementation, the heatmap visualization 1704 shows a range of colors conveying the volume of social media content in the geographic location to help the user or client understand the geographic layout of social media content or activity.

In one embodiment, the heatmap visualization 1702 permits the user, or client, to interact with the geographically delineated content in the associated geographic location. For example, in response to selection of one or more indicators 1704 (demonstrated generally by selection circle 1706), the interface 1700 is configured to display the geographically delineated content 1708 associated with the underlying geographic location. As shown in interface 1700, geographically delineated content can include any type of media posts, such as social media content. For example, geographically delineated content 1708 is shown in FIG. 17 as including photos and text. In various embodiments, interface 700 can show the date, or time, of creation of the geographically delineated content.

In further embodiments, the interface 1700 further includes a timeline indicator 1710 permitting the user, or client, to define a time period from which the interface 1700 will display geographically delineated content. For example, FIG. 17 shows a time period ranging from Nov. 14, 2014, to Nov. 21, 2014. Although not shown, in additional embodiments, the interface 1700 can further include one or more filter indicators permitting the user to filter geographically delineated content associated with the defined geographic location in the heatmap 1702. For example, user, or client, activation of a filter including geographic location shape, time period, content source, content type, hashtags, keywords, @mentions, venue, user age, user sex, use topic interest, user domicile, or user influence level, permits the user, or client, to further refine or tailor the aggregated content.

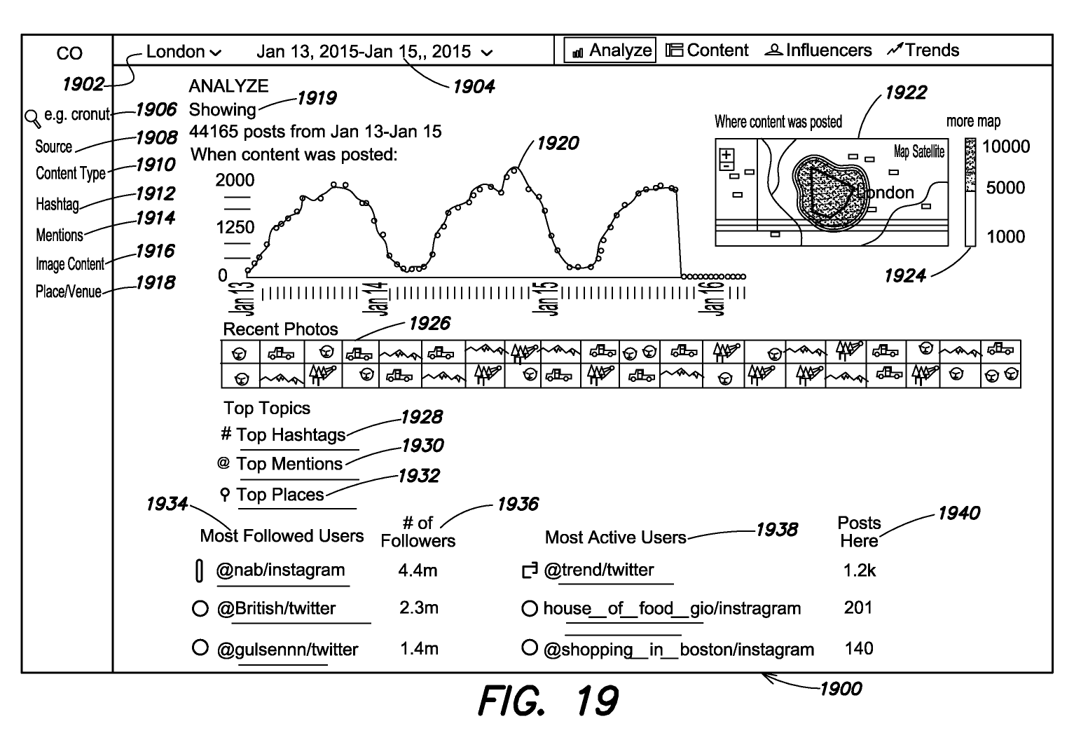

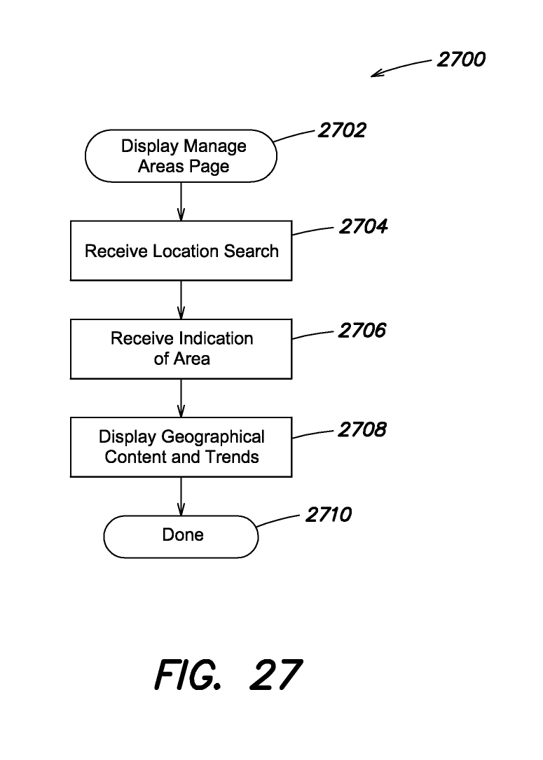

FIG. 27 illustrates a block diagram showing a process flow for receiving an input identifying a geographic location and displaying enriched aggregated geographically delineated content and incongruities in the enriched aggregated geographically delineated content. Process 2700 begins by displaying a “manage areas” interface (e.g. “page”) at block 2702. The manage areas interface 1800 may allow a user to add or edit defined locations that are associated with a user account. As discussed herein, defined locations may include drawn polygons on a map. FIG. 18 illustrates an example manage areas interface 1800 according to one embodiment. The interface 1800 may be displayed in a website or mobile application, and may include a listing of previously identified geographic locations. For example, this may include saved input or polygons listed according to an associated title identifier.

FIG. 18 also shows an option to receive daily digest messages (e.g., emails) 1806, an edit indicator 1808 permitting a user to edit the identified geographic location (e.g., polygon) of a listed location, and an option to delete the location 1810. The manage areas interface 1800 may also include an add area indicator 1816 permitting the user to identify a new geographic location. New locations may be identified in an interface such as interface 1500 discussed above with reference to FIG. 15A. The interface 1800 may also include a content alerts input 1812 and an influence alerts input 1814 that allow the user to customize alert notifications (e.g., sent via email notifications, push notifications, SMS notifications, etc.) for notification of a detected incongruity relating to media post content or author influencers.

Referring back to FIG. 27, the process 2700 can include receiving a location search to identify a map (block 2704), and responsive to displaying the map, receiving an input identifying a geographic location for which to aggregate content (block 2708). Often this may include permitting the user to define a polygon in the displayed map. For example, the input identifying a geographic location may be received from a user by drawing a shape on the map indicating the identified location (discussed in detail above).

While not shown, in some embodiments, when the user identifies multiple geographic locations, an interface may offer to either compare the geographically delineated content of the identified locations or display the content of identified locations as a combined whole. In various embodiments, the interface permits the user to define a first polygon in the displayed map, and subsequently permits the user to define a second polygon in the displayed map. In other embodiments, multiple locations may be defined in separate maps. In still further embodiments, a user may identify multiple related locations as a single logical location (e.g., Coliseums in Rome). For example, if a user wants to receive content and trends from all music venues in Boston, Mass., that user may identify all desired music venues in the interface. In response, a service, such as service 101 discussed above, is configured to control the interface to display incongruities and trends based on a combination of all of the identified geographic locations. In various embodiments, one or more of the interfaces are configured to display a heatmap visualization of all of the identified geographic locations, in one map. In some additional embodiments, the interface may include an option to switch between each defined geographic location individually. For example, one embodiment permits a retail business owner to view all media posts associated with her business, despite the disparate locations of the physical stores.

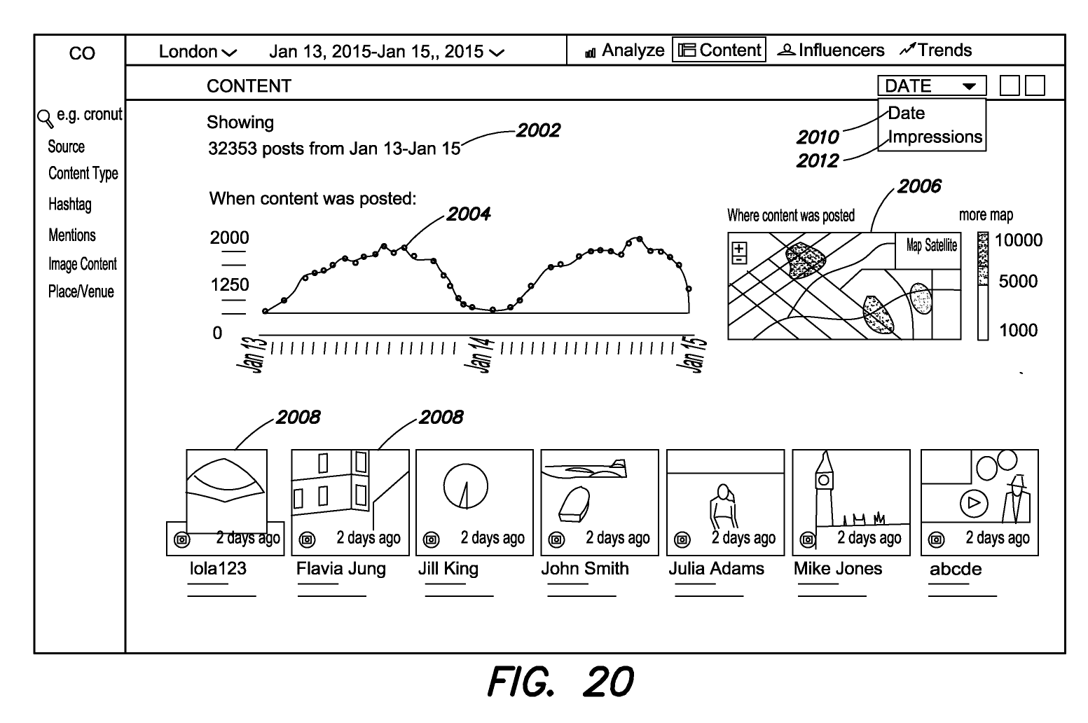

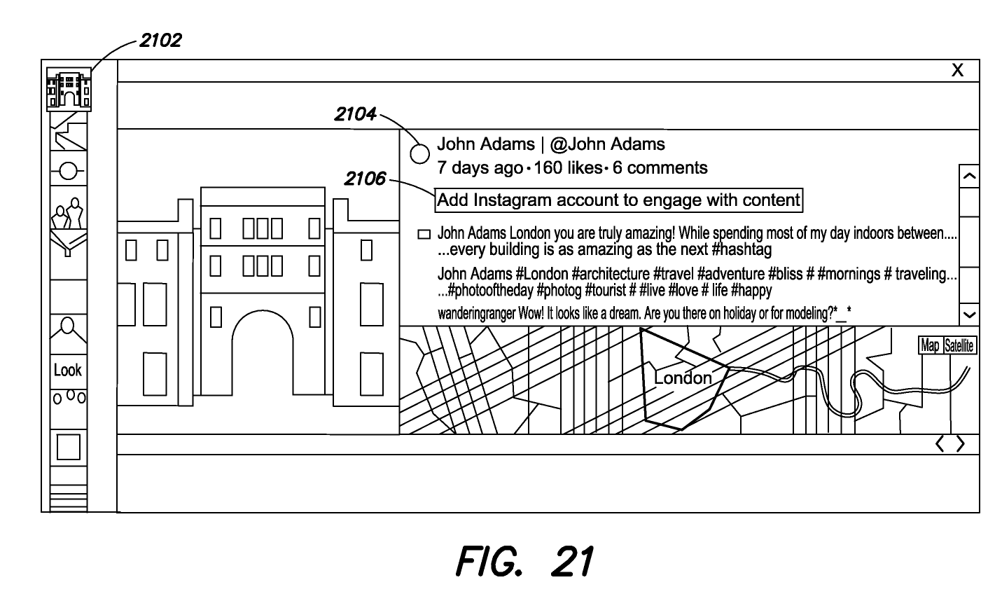

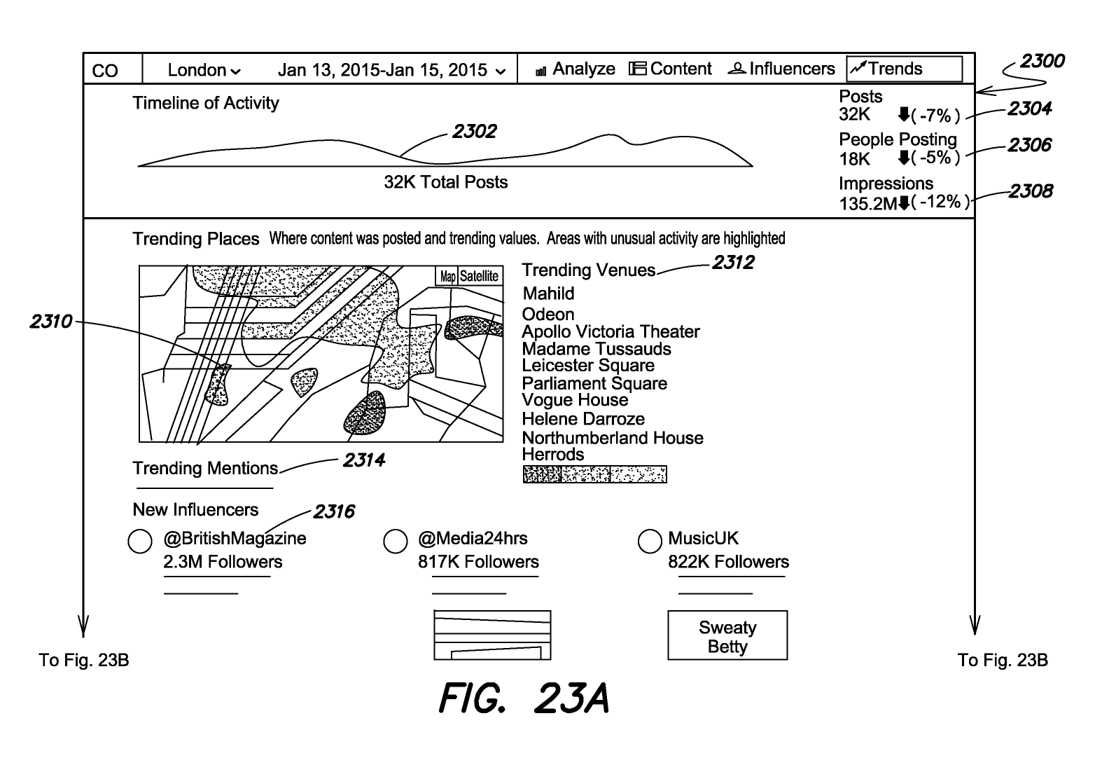

As described above, the user or client can label or otherwise “name” a polygon or geographic location specified in the input. In various embodiments, this includes naming and storing an identification of multiple geographic locations. As referred to above with reference to FIG. 16, this may include a title identifier. After receiving the input identifying a geographic location, or receiving selection of a title identifier, the process 2700 may include displaying geographically delineated content, enriched geographically delineated content, or detected incongruities (block 2708). In various embodiments, one or more interfaces are configured to display such content and incongruities. Examples of interfaces for displaying geographical content and incongruities are shown in FIG. 19, FIG. 20, and FIG. 22.

FIG. 19 illustrates an example interface for displaying detected incongruities, such as trends. A home interface 1900 displays aggregated geographically delineated content based on the identified location and displays individual media posts within the aggregated content, along with one or more filters that permit a user to narrow the displayed content. The user may alternate between one or more locations shown via control 1902 and enter a time frame via timeline indicator 1904. Timeline indicator 1904 may display a calendar of dates and times that permit the user to elect the desired time frame. According to various embodiments, the interface 1900 may permit a user to store and compare different dates and times for an identified geographic location. For example, the user may compare a week from January 2015 to a week from January 2014. Responsive to user entry of a time frame, the interface can be configured to display changes in the aggregated geographically delineated content over the identified time frame. The interface may also permit a user to narrow the displayed geographically delineated content based on filters including a keyword search input 1906, source (e.g., Facebook, Instagram, Twitter, etc.) input 1908, content type (e.g., photo, text, video etc.) input 1910, hashtag (e.g., #London, #fashion, etc.) input 1912, mentions (e.g., @NBA, etc.) input 1914, image content (e.g., person, food, etc.) input 1916, place/venue (e.g., London, Big Ben, etc.) 1918, etc. As such, interface 1900 not only allows a user to view media posts associated with an identified location, it permits a user to view changes in content over time, or based on specific enrichment data not provided by the source of the content.

In some implementations, the displayed geographically delineated content may also include a volume of the media posts within the aggregated content 1919. The display may also include a graphical depiction indicating when the content was posted (e.g., timeline 1920). In further embodiments, it may include a heatmap visualization 1922 indicating a volume of media posts of the aggregated content associated with a geographic location. The heatmap visualization 1922 may be zoomed-in and may include a key 1924. The key 1924 may be edited to display a larger or smaller range. Additionally, the interface 1900 may be configured to receive an input on a location of the heatmap 1922 and filter the displayed geographically delineated content based on the input. For example, selection of an indicator layered over the map in the heatmap visualization permits a user to view content associated with the discrete location underlying the indicator.

In various implementations, sections of the timeline 1920 are also responsive to user selection. The timeline 1920, of user interface 1900, may be configured to narrow the timeline identified by the user responsive to a particular selection. For example, if a user selects the beginning one-fourth of the timelines 1920, the service may display a detailed interface that displays all aggregated geographically delineated content having a date corresponding to the beginning of the timeline 1920, for example early in the morning of Jan. 13, 2015.

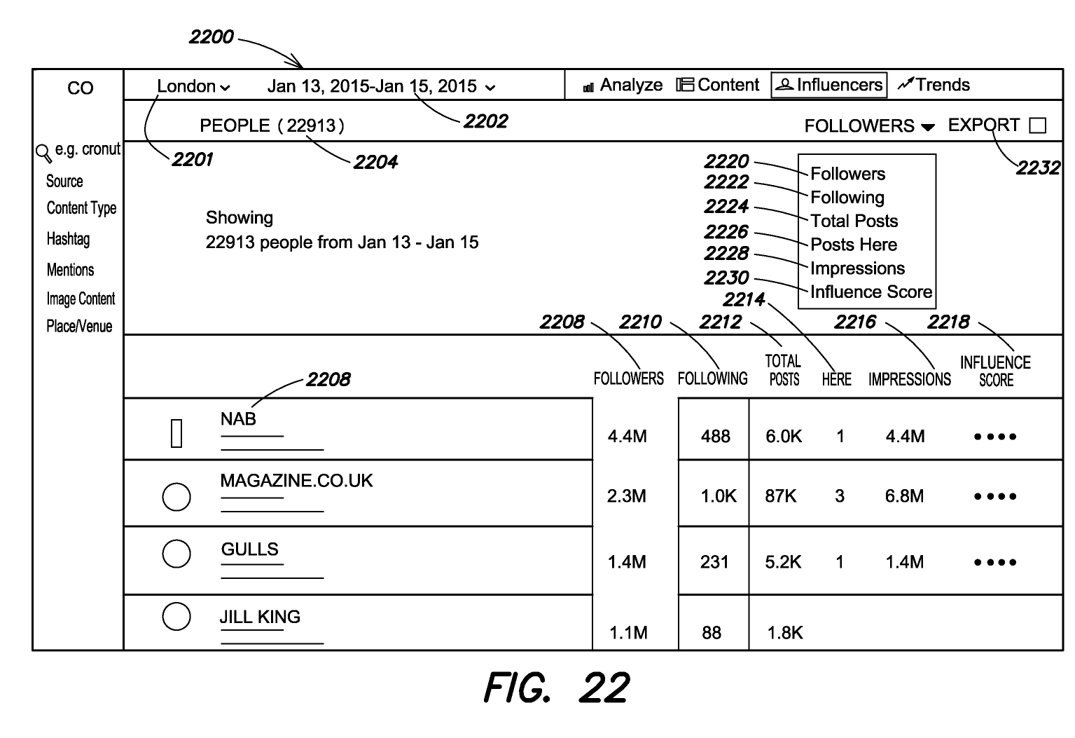

In various embodiments, the interface 1900 may permit a user to select any individual media post within the displayed aggregated geographically delineated content or enriched aggregated geographically delineated content. FIG. 21 illustrates an example user interface 2100 for displaying detailed information relating to one or more media posts. Often this includes displaying enrichment data associated with individual media posts of the plurality of media posts of the aggregated geographically delineated content, such as author profile information, content information, location information, event information, or venue information. Interface 2100 may be configured to display individual media posts of the aggregated content in a scrollable area 2102. The scrollable area 2012 permits the user to selectively cycle through media posts within the enriched aggregated geographically delineated content. Individual media posts are selectable by the user.

Responsive to selection of an individual media post, the interface 2100 is configured to enlarge and display the selected post. The enlarged post may be accompanied by one or more additional enrichments (i.e., enrichment data). For example, FIG. 21, shows the media post accompanied with enrichment data including when the media post was generated, how many likes the media post received, and how many comments are on the media post. The interface may display options for a user to like or comment directly from the user interface 2100. The interface 2100 may also provide an input 2106 permitting the user to link with a social network account (e.g., Twitter, Facebook, Instagram, etc.) to engage with the displayed media content. The interface 2100 may also display a description and hashtags of the post generated by the author 2104 of the media post. Additionally, the interface 2100 may also display any comments associated with the media post. A geographic location associated with the media post may additionally be displayed with the media post. For example, FIG. 21 shows a marker placed within the user defined polygon on a map of the identified geographic location.

Returning to FIG. 19, in one example, the interface 1900 is configured to display recent media posts having photographs 1926 associated therewith. While shown in FIG. 19 as a collage, in various embodiments, the interface is configured to display the photographs 1926 based on enrichment data associated with the respective media post. For example, photographs 1926 may be arranged by scene depiction, photograph topic, or location. The photographs 1926 may update in real time (e.g., as new content is received) or only change when the interface is refreshed. If a chosen time frame does not include the current date, the interface 1900 may be configured to display the photos 1926 received at the last time of the identified time frame.

The interface 1900 may also include other enrichment data, including, top hashtags 1928, top mentions 1930, top places 1932, most followed users 1934, and most active users 1938. Each of the foregoing can be based on the identified geographic location and time frame. For example, if the time frame is defined as one week, the interface 1900 may display the top hashtags 1928 from the whole week. In various embodiments, the interface 1900 is configured to receive a user selection of one or more of the enrichments, and filter the displayed aggregated content based on the selection. For example, if a user selected “#fashion”, the interface 1900 may modify the display to only present aggregated content relating to fashion.

According to some implementations, the interface 1900 may also display author profile information. This may include a list of the most followed authors (e.g., users) 1934 along with the number of followers for each author 1936, and the latest media post of each author. Similarly, the interface 1900 may display the most active authors (e.g., users) 1938, along with the number of media posts each author has made 1940, and the latest post each author posted. Author profile information may be aggregated for all social media content providers, or only selected (e.g., user selected) social media content providers. In some embodiments, the interface may permit a user to select one or more of the authors and display an interface associated with the selected author. In other embodiments, the interface may display options to permit access or links to the author's associated social networking profiles at an associated content provider's platform (e.g., a user's Twitter profile).

FIG. 20 illustrates one example interface for displaying enriched aggregated geographically delineated content, according to one embodiment. The interface 2000 may display enriched content posted within the identified geographic location and time frame. In various embodiments, the interface 2000 may display the volume of media posts available within the given time and date range (shown as 2002). The interface 2000 may also display a graphical depiction, such as timeline 2004, illustrating when individual media posts of the enriched aggregated geographically delineated content were posted over the received time period (e.g., how much content was posted at each date and time). The timeline 2004 may receive input to zoom in and out, as well as, display samples of enriched content for each area of time shown (e.g., a user may hover above a section of the timeline 2004 to see the enriched content that is associated with the selected time). As discussed herein, enriched aggregated geographically delineated content may also be displayed as a heatmap visualization 2006.

Media posts 2008 of the enriched aggregated geographically delineated content may additionally be displayed by the interface 2000, including images, videos, and text from the received location and time range. Often this will include displaying enrichment data. Additionally, the displayed media posts 2008 may be sorted, for example, by date 2010 or by impressions 2012. As described above, impressions 2012 may include how many times a media post (e.g., a photo) has been viewed. In some examples, media posts 2008 may also be sorted by likes, comments, type, connection strength to content (e.g., display content from friends first, then secondary friends, etc.). Additionally, media posts 2008 may also be filtered by any of the filtering options as mentioned above with reference to the interface 1900 of FIG. 19. The filtering options may include keyword filters, source filters, content type filters, hashtag filters, mentions filters, image content filters, place/venue filters, etc. For example, filtering may include grouping related content. It is appreciated that enrichment data permits grouping and displaying groups of aggregated geographically delineated content, and grouping and displaying individual media posts within enriched aggregated geographically delineated content, that would not have otherwise been related.

FIG. 22 illustrates an example interface 2200 for displaying author profile information, such as influence, according to one embodiment. As discussed herein, media posts may have author profiles associated therewith. Often author profiles will include an influence level (i.e., influence). For example, influence level may include the number of followers an author has. The interface 2200 may be configured to display the authors having the highest influence (i.e., “high influencers) in the identified geographic location 2201 at the identified time frame 2202. The interface may display the total number of authors within the location and time frame, as well as, a listing of the high influencer's name 2206, follower count 2208, following count 2210, total posts 2212, total posts in the identified geographic location during the time frame 2214, impressions 2216, and influence 2218. It should be appreciated that this information may be displayed in different combinations, alone, or with other data.

The interface 2200 may also display each author's location, social network information, website, and latest media post, such as status updates. Additionally, the interface 2200 may permit the user to sort the displayed authors by how many follows the author has 2220, how many other authors the authors are following 2222, how many posts the authors have made 2224, how many posts the authors have made within the identified geographic location and time frame 2226, impressions 2228, and influence 2230, among other information. The interface 2200 may also permit the user to export the author information displayed on the user interface 2200, responsive to an input on an export control 2232. The author information displayed in the interface 2200 may be exported into, for example, a comma separated value (CSV) file. The CSV file may include author information relating to each author associated with media posts within the aggregated content, including a content provider from which the media posts associated with the respective author was aggregated (e.g., Instagram, Twitter, etc.). The file may also include additional author profile information including the author's display name, the author's username, the location of the author, the author's website, the author's biography, the author's source application URL, the author's follow count, a count of how many authors are following the author, the author's total post count, the author's post count in the area, how many impressions the author has, and the author's influence score.

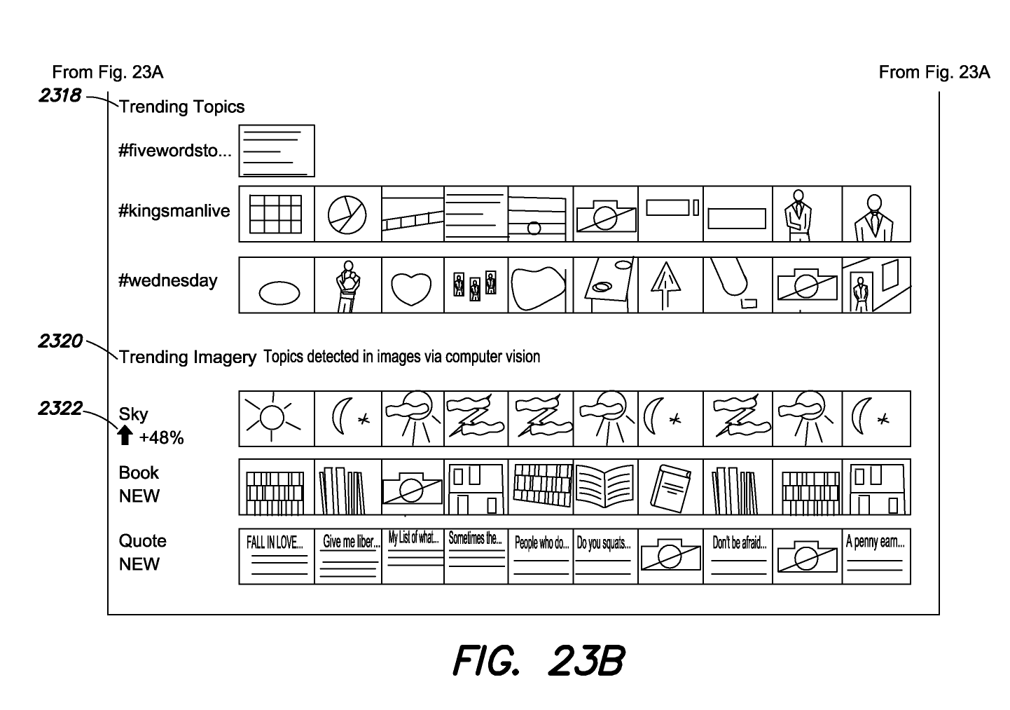

FIG. 23A-B shows an additional example interface for displaying detected incongruities, according to one embodiment of the present invention. The interface 2300 provides a timeline of activity 2302 to display volume of total media posts of the aggregated geographically delineated content during discrete periods in the time frame. The interface 2300 also displays the number of media posts 2304 that were posted in the time frame, as well as, the percent change in enrichment data from a temporally preceding time frame. For example, in the embodiment illustrated in FIG. 23A-B, the total number of posts had a −7% change (shown as 2304). In various embodiments, this is ascertained by a service, such as service 101 discussed above with reference to FIG. 1. The change 2304 can be calculated by comparing the volume of media posts in aggregated geographically delineated content from Jan. 11, 2015 to Jan. 13, 2015 and the volume of media posts of a second set of aggregated geographically delineated content. Often the aggregated content includes enriched aggregated geographically delineated content. In this example, the volume of posts from the second time frame may have been around 34,400 to cause a −7% drop to 32,000. The interface 2300 may also display the number of authors posting 2306, and the number of impressions 2308 received by the media posts.

In some examples, the interface 2300 can be configured to display a heatmap visualization of trending locations 2310 and a list of trending venues 2312. As used herein, trending locations and venues refers to locations and venues having an increase in volume of media posts associated therewith. The interface 2300 may also display trending mentions 2314 and new influencers 2316. New influencers 2316 may be influential authors who are new, or do not generally generate media posts in the identified geographic location. As described herein, an influence level for a author may be based on the number of followers, the number of friends, number of re-tweets, amount of comments received, characteristics of friends or followers, or any other activity of the author. New influencers 2316 may be, for example, new to the area or in the area temporarily. Such a determination may be made, for example, by determining (e.g., by service 101) a number of authors within an identified location, and determining whether the authors generating content within the location generally post in the location, or have not previously posted in the location.

The interface 2300 may display the username of the new influencers 2316 along with a follower count, description, and content (e.g., status update, photo, video, etc.). The interface 2300 may also display trending topics (e.g., hash tags) 2318 and trending imagery 2320. Any of the trending venues 2312, trending mentions 2314, trending topics 2318, and trending imagery 2320 may be displayed with an associated percentage increase or decrease 2322 that may be calculated similar to the percentage increase or decrease of the volume of posts (shown as 2304). As used herein, trending locations, venues, imagery, topics, authors, and influencers, may all be based on detected incongruities in enriched geographically delineated content. It is appreciated that incongruity includes any increase or decrease in volume associated with a media post that may be related to a discontinuity in the aggregated content.

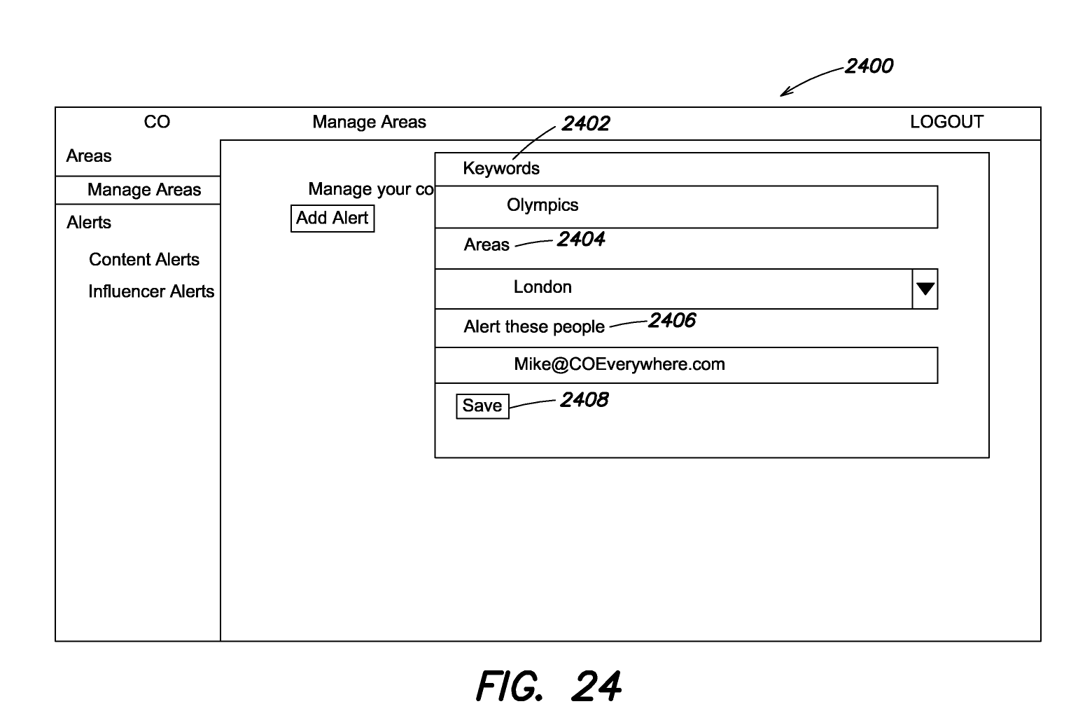

FIG. 24 shows an example interface in which alert conditions may be entered, according to one embodiment of the present invention. For example, FIG. 24 shows an alert condition interface for generating alerts based on alert parameters including keywords. The interface 2400 may receive the alert parameters, such as keywords 2402, and an identified geographic location (e.g., area 2404). Furthermore, the interface 2400 may be configured to receive contact information 2406. In further embodiments, the interface 2400 may also be configured to receive a plurality of identifications of geographic locations permitting the user to identify more than one location 2404. For example, if a user wanted to track the keywords “eagle sighting” in two separate locations, the interface 2400 may permit the user to identify both locations, as well as, the keyword “eagle”. In response to satisfaction of the alert condition, the interface 2400 is configured to display or otherwise communicate an alert to the user. In various embodiments, this includes sending an alert to the received contact information 2406. For example, responsive to identifying that one or media posts in the identified geographic location contain the keyword “eagle”, the interface can be configured to display or communicate the alert, optionally including the associated media posts. In other implementations, the alert may be a push notification, an email, or an SMS text message. In other implementations, the interface 2400 may permit the user to add, delete, or otherwise modify alert conditions or parameters. In various embodiments, alert parameters can include, and displayed alerts can include any enrichment data discussed herein.

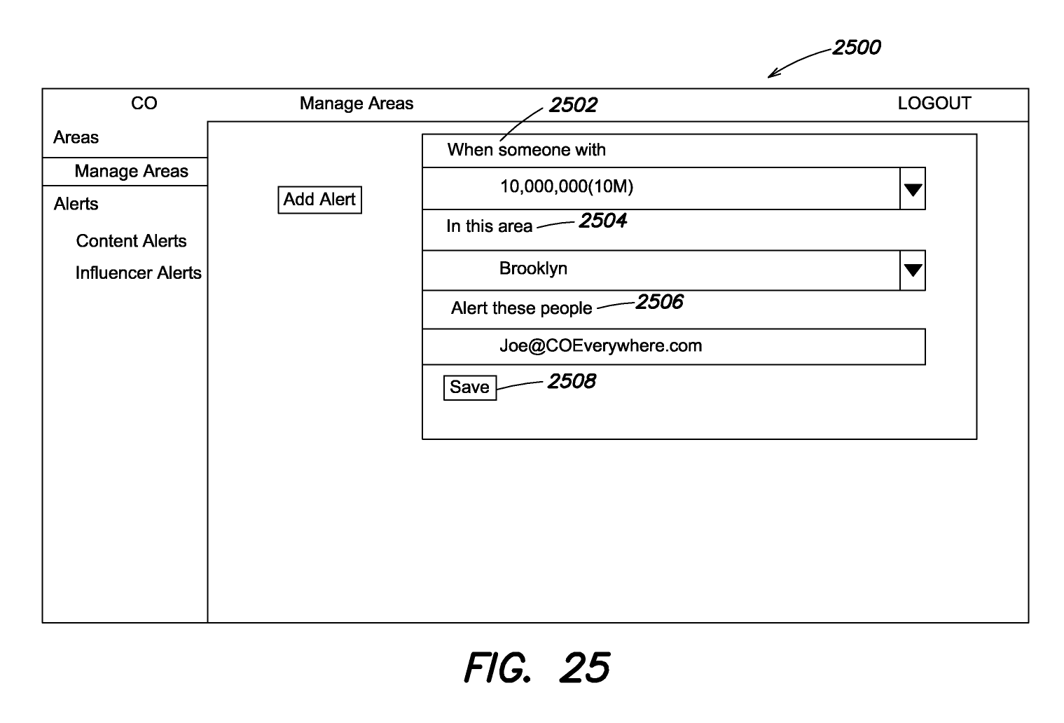

FIG. 25 illustrates an additional interface in which alert conditions may be entered, according to one embodiment of the present invention. For example, FIG. 25 shows an interface configured to generate alert conditions based on alert parameters including author influence. The interface 2500 can be configured to receive alert conditions specifying alert parameters for influencer notifications. In additional embodiments, the interface 2500 may display or otherwise communicate alerts to users who want to stay informed about authors, such as high influencers, in an area. The interface 2500 may receive the alert parameters, such as follower count 2502, and an identified geographic location (e.g., area 2504). Furthermore, the interface 2500 may be configured to receive contact information 2506. In various embodiments, the interface 2500 permits a user to define a follower count threshold. For example, the alert parameter may include a follower count threshold of 10,000 followers. Similar to the interface described herein with reference to FIG. 24, in response to satisfaction of the alert condition, the interface 2500 is configured to display or otherwise communicate an alert to the user. In various embodiments, this includes sending an alert to the received contact information 2506. For example, responsive to identifying that one or more authors in the identified geographic have a follower count above 10,000 followers, the interface 2500 can be configured to display or communicate the alert, optionally including associated author profile information. In other implementations, the alert may be a push notification, an email, or an SMS text message. In other implementations, the interface 2500 may permit the user to add, delete, or otherwise modify alert conditions or parameters. In various embodiments, alert parameters can include, and displayed alerts can include any enrichment data discussed herein.

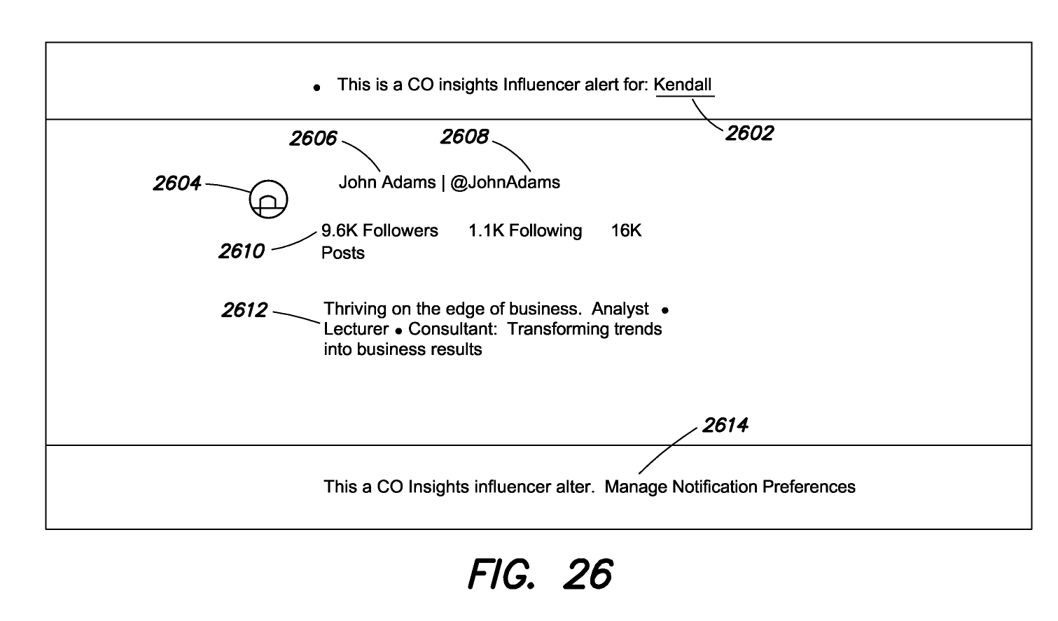

FIG. 26 shows an example alert. The alert may be received, for example, via an email or push notification. The alert includes the geographic location that the alert notification is associated with 2602, the author profile information associated with the generator of the media post (e.g., avatar 2604, author name 2606, username 2608, follower and post information (e.g., follower count, following count, number of posts) 2610, and author bio 2612). The alert notification may also include a link 2614 to manage notification preferences (e.g., change a follower count range, an area, or update contact information).

Accordingly, embodiments disclosed herein include services, application systems, applications, and methods for providing geographically delineated content. Geographically delineated content can include social media content that is relevant to one or more geographic locations. For example content can include text, photographs, videos, and/or audio files. Content can be provided by one or more social media content providers, online repositories of information, or any other provider of location-based relevant content. Although social media content providers as described herein include social media platforms such as Twitter, Facebook, MySpace, LinkedIn, Pinterest and Tumblr, in further embodiments, providers can include any social media content provider as is understood in the art.

What is claimed is:

1. A computer system comprising:
a location-based service including a distributed computer system having at least one processor;
a delineation component executable by the at least one processor and configured to query at least one social media content provider and aggregate geographically delineated content including a plurality of media posts each generated by an author, the content being received from the at least one social media content provider;
a deconstruction component executable by the at least one processor and configured to automatically deconstruct individual media posts of the plurality of media posts into a plurality of dimensions;
an enrichment component executable by the at least one processor and configured to:
automatically aggregate enrichment data related to at least one of the dimensions of each of the individual media posts, the enrichment data including at least author profile information associated with an author profile of the author that generated the respective media post, and
responsive to aggregating the enrichment data, enhancing the plurality of media posts with the enrichment data to generate enriched aggregated geographically delineated content; and
a communication component configured to distribute the enriched aggregated geographically delineated content.

2. The system according to claim 1, wherein the plurality of media posts includes at least social media content.

3. The system according to claim 1, further comprising an interface configured to receive an input identifying a geographic location, and wherein the delineation component is configured to query the at least one social media content provider responsive to receiving the input.

4. The system of claim 1, wherein the author profile includes a description of the characteristics of the author that generated the respective media post, the characteristics determined from a plurality of social media content providers.

5. The system of claim 4, wherein the author profile information includes one of author identification, author preferences, author interests, author sentiments, author influence, author connections, author activity, author gender, approximate author age range, and author local location.

6. The system of claim 5, wherein the author profile includes a queryable profile identifier and the system further comprises an author profile database configured to index the author profile respective to the author profile identifier.

7. The system of claim 6, wherein the plurality of dimensions includes an author dimension and the enrichment component is further configured to analyze meta information associated with the author dimension of one of the plurality of media posts to realize the profile identifier of the author profile and query the profile database based on the realized profile identifier.

8. The system according to claim 5, wherein the enrichment component is further configured to update the author profile responsive to aggregating geographically delineated content.

9. The system according to claim 1, wherein the plurality of dimensions include an image dimension and the enrichment component is further configured to analyze meta information associated with the image dimension of individual media posts of the plurality of media posts to determine enrichment data including at least one of a photograph topic, a photograph scene, a depicted logo, facial features, spam, and memes.

10. The system according to claim 1, wherein the plurality of dimensions further includes a content dimension and the enrichment component is further configured to analyze meta information associated with the content dimension of individual media posts of the plurality of media posts to determine enrichment data including at least one of topics, keywords, hashtags, @mention, and social velocity.

11. The system according to claim 10, wherein the enrichment component is further configured to cross-reference the content dimension of a first media post with one or more content dimensions of one or more additional media posts of the aggregated geographically delineated content.

12. The system according to claim 11, wherein the enrichment component is further configured to group related media posts responsive to cross-referencing the content dimension of the first media post with one or more content dimensions of one or more additional media posts.

13. The system according to claim 1, wherein the plurality of dimensions includes a location dimension and the enrichment component is further configured to analyze one or more location references associated with the location dimension of individual media posts of the plurality of media posts to determine enrichment data including venue location, time, weather, precise location, and genuine location.

14. The system according to claim 13, wherein analyzing one or more location references includes analyzing time stamps and associated locations of historic media posts of the author that generated the respective media post.

15. The system according to claim 1, further comprising an enrichment database configured to store the enriched aggregated geographically delineated content.

16. The system according to claim 1, wherein the system further comprises a relation component executable by the at least one processor and configured to determine a heatmap visualization from the enriched aggregated geographically delineated content.

17. A computer-executed method comprising acts of:
querying at least one social media content provider;
aggregating geographically delineated content from the at least one social media content provider, the content being received from the at least one social media content provider and including a plurality of media posts each generated by an author;
deconstructing, automatically, individual media posts of the plurality of media posts into a plurality of dimensions;
aggregating, automatically, enrichment data related to at least one of the dimensions of each of the individual media posts, the enrichment data including at least author profile information associated with an author profile of the author that generated the respective media post;
responsive to aggregating the enrichment data, enhancing the plurality of media posts with the enrichment data to generate enriched aggregated geographically delineated content; and
distributing the enriched aggregated geographically delineated content.

18. The method according to claim 17, wherein the plurality of media posts includes at least social media content.

19. The method according to claim 17, further comprising: receiving an input identifying a geographic location, and wherein querying the at least one social media content provider is performed responsive to receiving the input.

20. The method according to claim 17, wherein the author profile includes a description of the characteristics of the author that generated the respective media post, the characteristics determined from a plurality of social media content providers.

21. The method according to claim 20, wherein the author profile information includes one of author identification, author preferences, author interests, author sentiments, author influence, author connections, author activity, author gender, approximate author age range, and author local location.

22. The method according to claim 21, wherein the author profile includes a queryable profile identifier and the method further comprises indexing the author profile in an author profile database relative to the profile identifier.

23. The method according to claim 22, wherein the plurality of dimensions includes an author dimension and the method further comprises analyzing meta information associated with the author dimension of one of the plurality of media posts to realize the identifier of the author profile and querying the author profile database based on the realized profile identifier.

24. The method according to claim 21, further comprising: updating the author profile responsive to aggregating geographically delineated content.

25. The method according to claim 17, wherein the plurality of dimensions include an image dimension and the method further comprises analyzing meta information associated with the image dimension of individual media posts of the plurality of media posts to determine enrichment data including at least one of a photograph topic, a photograph scene, a depicted logo, facial features, spam, and memes.

26. The method according to claim 17, wherein the plurality of dimensions further includes a content dimension and the method further comprises analyzing meta information associated with the content dimension of individual media posts of the plurality of media posts to determine enrichment data including at least one of topics, keywords, hashtags, @mentions, and social velocity.

27. The method according to claim 26, wherein analyzing content associated with the content dimension includes cross-referencing the content dimension of a first media post with one or more content dimensions of one or more additional media posts of the aggregated geographically delineated content.

28. The method according to claim 27, further comprising grouping related media posts responsive to cross-referencing the content dimension of the first media post with one or more content dimensions of one or more additional media posts.

29. The method according to claim 17, wherein the plurality of dimensions includes a location dimension and the method further comprises analyzing one or more location references associated with the location dimension of individual media posts of the plurality of media posts to determine enrichment data including venue location, time, weather, precise location, and genuine location.

30. The method according to claim 29, wherein analyzing one or more location references includes analyzing time stamps and associated locations of historic media posts of the author that generated the respective media post.

31. The method according to claim 17, further comprising: storing the enriched aggregated geographically delineated content.

32. The method according to claim 17, further comprising: determining a heatmap visualization from the enriched aggregated geographically delineated content.
